(19) United States
(12) Patent Application Publication
(10) Pub. No.: US 2025/0045192 A1
(43) Pub. Date: Feb. 6, 2025

(54) TECHNIQUES FOR TELEMETRY DATA COMPARISON FOR REGRESSION DETECTION

(71) Applicant: Oracle International Corporation, Redwood Shores, CA (US)

(72) Inventors: Kevin J. Cirone, Tewksbury, MA (US); Blake T. Sullivan, Redwood CIty, CA (US); Dipankar Bajpai, Chelmsford, MA (US)

(73) Assignee: Oracle International Corporation, Redwood Shores, CA (US)

(21) Appl. No.: 18/364,327

(22) Filed: Aug. 2, 2023

(51) Int. Cl. G06F 11/36

(52) U.S. Cl. CPC G06F 11/3692; G06F 11/3636; G06F 11/3664

(57) ABSTRACT

Disclosed techniques relate to curing defects in software. In an example, a method involves receiving, from a first and second tracer, a first and second tracing log respectively. The first and second tracing log include log tracing data represented by a plurality of spans of respective instances of a web page application. The plurality of spans are associated with corresponding events of the respective instances of the web page application. The method further involves generating a first logical tree from the first tracing log and a second logical tree from the second tracing log. The logical trees include a respective plurality of nodes to represent chronological order of events within respective instances of the web page application and an additional node outside of the chronological order. The method further involves identifying correspondences and differences between nodes of the logical trees and generating a report on the set of spans.

### CROSS-REFERENCES TO RELATED APPLICATIONS

This application is related to co-pending U.S. Patent Application No. ______ titled “Instrumentation of soft navigation elements of web page applications” (Attorney Docket No. 088325-1384387-417000US) filed Aug. 2, 2023, co-pending U.S. Patent Application No. ______ titled “Instrumentation of web based applications affected by user inactivity” (Attorney Docket No. 088325-1384434-417100US) filed Aug. 2, 2023, and co-pending U.S. Patent Application No. ______ titled “Techniques for test automation generation from telemetry data” (Attorney Docket No. 088325-1384465-417200US) filed Aug. 2, 2023, the contents of which are hereby incorporated by reference in their entirety for all purposes.

### BACKGROUND

Traditional debugging techniques often struggle to detect and correct errors experienced by users in part because of difficulties faced by developers in recreating the environment where the users experienced the error. Disclosed solutions facilitate improved error detection and debugging using recreated environments based on telemetry data to overcome these deficiencies.

### BRIEF SUMMARY

In an aspect, a method involves receiving, from a first tracer configured to log tracing data for a first instance of a web page application, a first tracing log including information regarding a first plurality of spans. Each span of the first plurality of spans is associated with a corresponding event of the web page application. The method further involves generating, from the first tracing log, a first logical tree that includes a first plurality of nodes. Each node includes attributes of a respective span of the first plurality of spans and a first subset of the first plurality of nodes is arranged to represent a first chronological order of execution of events within the first instance of the web page application. The first plurality of nodes also includes a first additional node that is outside of the first chronological order. The method further involves receiving, from a second tracer configured to log tracing data for a second instance of the web page application, a second tracing log including information regarding a second plurality of spans. Each span of the second plurality of spans is associated with a corresponding event of the web page application. The method further involves generating, from the second tracing log, a second logical tree that includes a second plurality of nodes. Each node includes attributes of a respective span of the second plurality of spans and a second subset of the second plurality of nodes is arranged to represent a second chronological order of execution of events within the second instance of the web page application. Further, a second additional node of the second plurality of nodes is outside of the second chronological order. The method further involves extracting, from nodes of the first logical tree and the nodes of the second logical tree, a set of spans. Extracting includes identifying a correspondence between a first node in the first logical tree and a second node in the second logical tree and identifying a first difference between a first attribute of the first node and a second attribute of the second node. Extracting also includes identifying a plurality of common nodes between the first subset of the first plurality of nodes and the second subset of the second plurality of nodes and identifying a second difference between the first chronological order and the second chronological order. Further, extracting includes extracting one or more spans based on the first difference and the second difference. The method further involves generating a textual report of the set of spans.

In an additional aspect, the method further involves identifying, from the extracted spans, a software defect in the second instance of the web page application and responsive to identifying the software defect, correcting the software defect in the second instance of the web page application.

In a further aspect, the attributes include one or more of: a type of error associated with the span, a timestamp, a duration of the span, a type of operation, a type of event, a parent span of the span, and a child span of the span.

In a further aspect, the method further involves determining, from the identified spans, the first difference and the second difference to be greater than a predetermined threshold and receiving, from a third tracer configured to log tracing data for a third instance of the web page application, a third tracing log including information regarding a third plurality of spans. Each span of the third plurality of spans is associated with a corresponding event of the web page application.

In a further aspect, the second instance of the web page application is a simulation of the first instance of the web page application.

In a further aspect, the textual report includes a comparison of the second logical tree and the second logical tree.

In a further aspect, the method further involves identifying an additional difference between an additional attribute of the first node and an additional attribute of the second node. The method further involves ignoring the additional difference based on attribute type.

The above methods can be implemented as computer-executable program instructions stored in a tangible computer-readable media and/or operating within a computer processor or other processing device and attached memory.

### BRIEF DESCRIPTION OF THE DRAWINGS

FIG. 1 depicts an example of a system for debugging a web-based application, according to an aspect of the present disclosure.

FIG. 2 depicts an example of a method used to gather telemetry data, according to an aspect of the present disclosure.

FIG. 3 depicts an example of a block diagram of the test environment generation architecture, according to certain aspects of the disclosure.

FIG. 4 depicts an example of a method to generate a test environment from a user's telemetry data, according to certain aspects of the disclosure.

FIG. 5 depicts an example of an instrumented application for generating span context, according to certain aspects of the disclosure.

FIG. 6 depicts tracer components within an instrumented application that are used to generate span context and logs, according to certain aspects of the disclosure.

FIG. 7 depicts an example of a span hierarchy, according to certain aspects of the disclosure.

FIG. 8 depicts a simplified representation of a telemetry tree builder and a script generator, according to certain aspects of the disclosure.

FIG. 9 depicts an example of a method for error detection within telemetry data, according to certain aspects of the disclosure.

FIG. 10 depicts an example of a comparison of span hierarchies, according to certain aspects of the disclosure.

FIGS. 11A and 11B depict examples of error reports, according to certain aspects of the disclosure.

FIG. 12 depicts a simplified diagram of a distributed system for implementing one of the aspects.

FIG. 13 is a simplified block diagram of components of a system environment by which services provided by the components of an aspect system may be offered as cloud services in accordance with an aspect.

FIG. 14 illustrates an exemplary computing subsystem, in which various aspects of the present invention may be implemented.

### DETAILED DESCRIPTION

Techniques disclosed herein provide solutions for automatically debugging enterprise applications by recreating an environment on a developer device from telemetry associated with a user device. Telemetry refers to gathering of reporting performance data about the runtime execution of software. Examples of such data include how often certain features on a web page or application are used, measurements of start-up time or execution time, whether a process crashed, failure information, and user experiences.

Telemetry data can be gathered on an application basis, or on a more granular level, such as runtime metrics on how long each process of the web page took to complete. Disclosed solutions use Application Programmer Interface (API) capabilities to enable access to the telemetry data.

As discussed, existing solutions suffer from deficiencies. For instance, software developers often have difficulties identifying and debugging errors from web-based applications because of the difficulty in recreating an environment or sequence of events that resulted in an error. Additionally, due to resource constraints, developers often limit the collection of telemetry data, which can further complicate the debugging process.

Techniques disclosed herein address these deficiencies by collecting telemetry data associated with events, such as user interactions and navigations, such that a developer is able to recreate the environment or sequence of events in which the user experienced the error. This allows the developer to recreate the error on a developer device. Developers using these techniques are also able to automatically extrapolate user actions from telemetry data when errors occur to provide swifter response to errors. Because these techniques produce an output script as an editable document, the editable document can be tailored to a different environment or to perform additional validation for debugging. These techniques include aspects that are self-validating, which adds confidence in the quality of the script and the simulation of the user actions.

To facilitate telemetry, within an enterprise application, one or more spans are created. As used herein, a span refers to a set of named operations that represent a unit of work. A particular span can refer to a process. A span has a span context. As used herein, a span context can include a trace identifier and a span identifier. Accordingly, a first process can have a first span and a second process a second span. If the second process is called by the first process, then the first and second spans are related by a parent-child relationship such that the first span is a parent and the second is a child. Tracking the spans of different processes facilitates a more detailed instrumentation.

Spans can be captured and emitted that correspond to when a priority element is rendered on the web page and to when the priority element is available, or ready. An element is ready when asynchronous processing relating to the element is complete, indicating when a complete experience is available to the user. Further, additional metrics can be gathered on when all such priority elements are ready. Disclosed techniques can therefore emit a span that encompasses an entire logical navigation of a single page web-application including indications of the loading of artifacts, timing details, and priority metrics that relate to the loading of prioritized page elements.

The following non-limiting example is introduced for discussion purposes. A web page application including a tracer application executes within a web browser on a computing device. The tracer application logs tracing data for the web page application. The tracing log includes a hierarchy of spans associated with execution of the web page application in the web browser. Each span from the hierarchy of spans represents an execution of operations associated with an event and includes an associated timestamp. Events may include user interactions and actions not triggered by users, such as loading, buffering, and rendering of elements. These spans and events facilitate the recreation of the environment in which the error occurred.

Continuing the example, the developer device receives the tracing log and identifies from the hierarchy of spans, one or more spans associated with a user interaction with the web page application. Based on the hierarchy of spans, the developer device generates a script, or set of instructions, that includes a chronological order of operations for execution in a test execution engine. The developer device can execute a second instance of the web page application or a simulation of the web page application and generate an associated span hierarchy for tracing data associated with the execution of the set of instructions. The developer device compares the span hierarchy from the execution of the instructions on the developer device to the span hierarchy of the user telemetry data. When the differences between the span hierarchies exceeds a predetermined threshold, the developer device generates another set of instructions (e.g., a second script) to be executed by the test execution engine. The developer device may generate additional instructions until differences between the span hierarchy of the user telemetry data and the span hierarchy from the execution of the additional instructions is below a predetermined threshold. When the differences between the span hierarchies is below a predetermined threshold, the developer device generates a textual report on the errors and differences between the span hierarchies. By comparing the span hierarchies and generating additional scripts when there are differences exceeding the predetermined threshold, the system is able to confirm that the developer device experiences errors experienced by the user on the user device.

The following additional non-limiting example is introduced for discussion purposes. A developer computing device receives, from a first tracer application executing a first instance of a web page application, a first tracing log. The developer computing device also receives, from a second tracer application executing a second instance of a web page application, a second tracing log. The developer computing device creates a first logical tree from the first tracing log and a second logical tree from the second tracing log. The developer computing device then extracts, from nodes of the first logical tree and the nodes of the second logical tree, a set of spans using one or more different techniques. Based on the extracted spans, the developer computing device can cure a software defect in the second instance of the web page application.

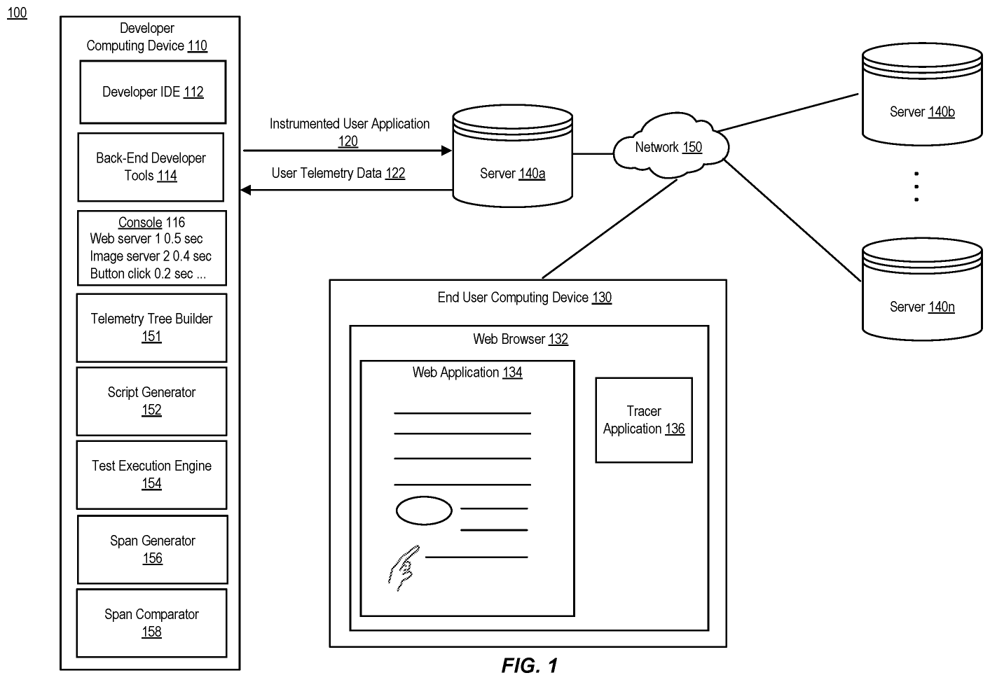

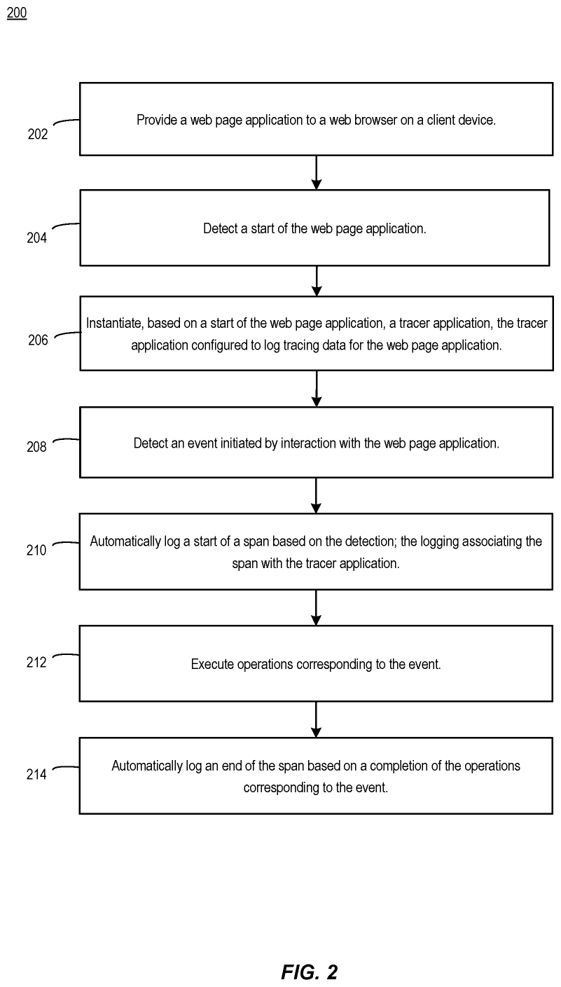

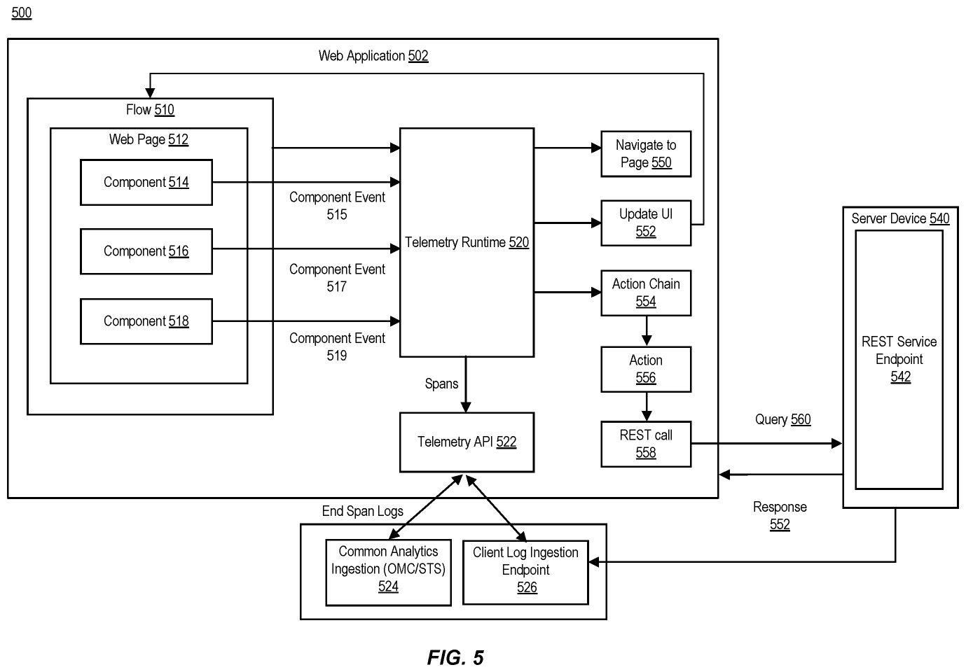

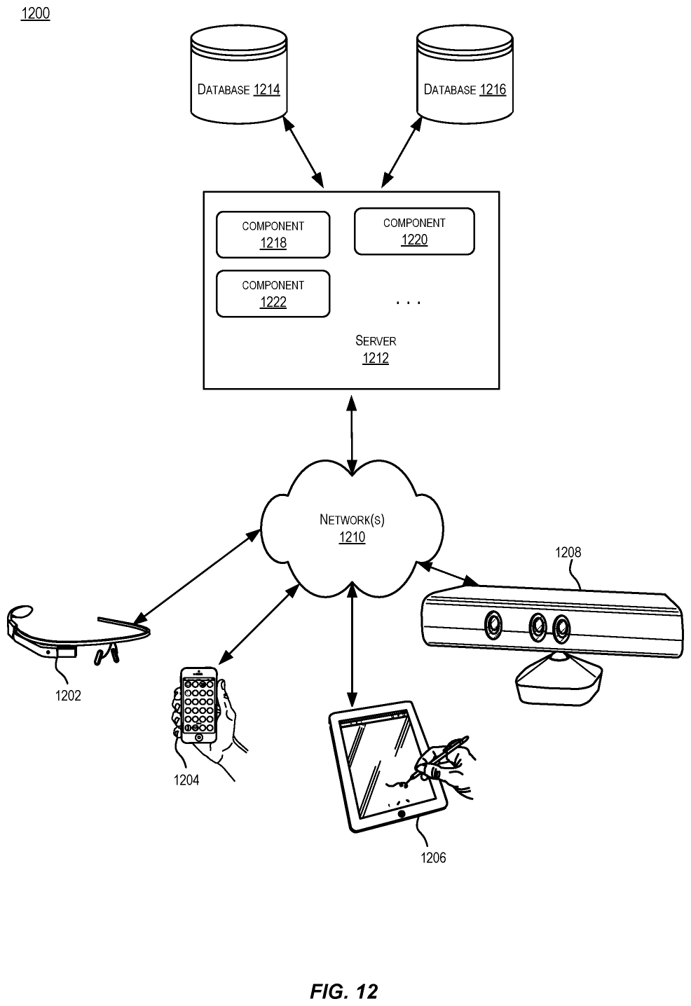

FIG. 1 depicts an example of a system 100 for debugging a web-based application, according to an aspect of the present disclosure. FIG. 1 depicts developer computing device 110, end user computing device 130, network 150, and servers 140a-n. In the example depicted in FIG. 1, developer computing device 110 builds instrumented user application 120 and deploys instrumented user application 120 to server 140a. Server 140a, in turn, serves the application to end user computing device 140. An example of a method used by an instrumented application to obtain telemetry data is shown in FIG. 2. An example of an instrumented application is shown in FIG. 5. Examples of suitable computing devices for developer computing device 110 and end user computing device 140 include those depicted in client computing devices 1202, 1204, 1206, and 1208 and examples of suitable servers include server 1212, are depicted in FIG. 12.

During or in connection with the execution of instrumented user application 120, end user computing device 140 may connect with one or more servers 140b-n to obtain different resources (e.g., images, scripts, etc.) and/or perform instrumentation functions. During or after execution of the instrumented user application 120, user telemetry data 122 is communicated back to developer computing device 110 for analysis.

Developer computing device 110 includes one or more of developer integrated development environment (IDE) 112, back-end developer tools 114, console 116, user telemetry data 122, telemetry tree builder 151, script generator 152, test execution engine 154, and span comparator 158. In some examples, the test execution engine 154 is a simulator in the back-end developer tools 114 or part of the developer integrated development environment (IDE) 112. In further examples, the test execution engine 154 is an additional instance of web application 134, including an additional tracer application on the developer computing device 110. Developer IDE 112 is a graphical development tool that provides compiling, linking, debugging, tracing, or other functionality. Back-end developer tools 114 can include one or more compilers, linkers, debuggers, simulators, and so forth. Console 116 is used to view user telemetry data 122 obtained by the execution of instrumented user application 120. As depicted, user telemetry data 122 includes data that a particular web page executed on “server 1” and took 0.5 seconds, an image load executed on “server 2” and took 0.4 seconds, and a button click caused 0.2 seconds of processing. In some examples, the user telemetry data 122 is sent to the developer computing device 110 in response to an error detected in the execution of the web application 134. This error may be reported by the user or may be automatically detected by the tracer application 136 or web application 134 based on the errors associated with the user telemetry data 122.

Telemetry tree builder 151 is an application configurable to generate a representation of a span hierarchy associated with the user telemetry data 122 received from the end user computing device 130. The telemetry tree builder 151 may be software executed on the developer computing device 110 or may be associated with a component or service provided on cloud service provider infrastructure. The representation may include a text file of the span hierarchy, such as a JSON file. The representation may also be a graphical representation of the span hierarchy, such as a tree plot of the span hierarchy with spans represented by nodes of the plot. The spans represented by nodes in the span hierarchy may include various attributes. Attributes may be metadata associated with the span and span hierarchy. These attributes may be tagged as associated with the telemetry data when measured by the instrumented application.

The spans and span hierarchy may include various attributes. Attributes may include timestamps, such as a timestamp associated with the beginning of a span and a timestamp associated with the end of a span. Another attribute may include the duration of the span, such as a measurement in cycles or time of the length of the span. Further attributes may include information associated with the location of the node and span within the hierarchy. This may include identifiers denoting a parent span and child span of the associated span. For example, when the span is a child span of a root node, and does not have its own child span, the identifiers may include “parent_span_id: rootNode” and “child_span_id: null.”

Additional attributes may include metadata the associated with an error flag or string indicating an error and type of error with a particular span. For example, when the time length (e.g., duration) of the span exceeds a predetermined threshold, the error flag or string may indicate that the application is experiencing an error such as but not limited to a regression error, buffering error, display error, and connection error.

The attributes further may include identifiers denoting operations and events associated with the span and with each other. For example, a span may be associated with a user click of a hyperlink. An attribute of said span may include metadata identifying an event resulting from clicking the hyperlink. One example of how the attribute may be displayed in code includes “container.event”: “hyperlinkClick”. The events may be associated with operations and vice versa as well. In continuing the example of the event associated with clicking a hyperlink, the operations associated with the event, span, span hierarchy, and portions of the span hierarchy, may include the user navigations of the mouse and clicking of the hyperlink. Operations may further include processing by processors, communications with servers, and further operation of hardware and software components unrelated to user actions.

Some events may also be unrelated to, or independent from a user's actions, and need not be triggered by user actions. For example, an event may include buffering and display of an element. Spans associated with events may occur asynchronously with spans from other events. Because spans may take place asynchronously, nodes on the same level of the span hierarchy may have varying timestamps and may have taken place in a different order.

In some examples, the telemetry tree builder 151 may receive the user telemetry data 122 from a telemetry database (not shown). The telemetry database may store telemetry data associated with various users and transmit the user telemetry data 122 when the user telemetry data 122 includes an error.

Script generator 152 produces a set of instructions (e.g., a script) associated with the events experienced by the user on the user device. The script may include events associated user actions and navigations, as well as events associated with the operation of the application, including events independent from the user's actions. For example, the script may include events associated with the movement of the user's mouse, and waiting periods associated with the buffering of an element. The script generator 152 produces the script based on the span hierarchy. The script generator 152 may use attributes of spans and nodes from the span hierarchy to generate a chronological sequence of events and operations to recreate the environment experienced by the user on the end user computing device 130. In some examples, the script is a puppeteer script of the user's actions to be executed within an instance of the web application 134 on the developer's device. In further examples, the script may also include commands to the system to perform operations.

In further examples, the script generator 152 may include pluggable output modules for outputting in different test formats such as Puppeteer and WebdriverIO.

Test execution engine 154 is software used to execute the script from the script generator 152. The test execution engine 154 may include an additional instance of web application 134 on the developer computing device 110. In some examples, the developer device may execute the script in simulator of the web application 134 in the back-end developer tools 114 on in additional instance of web application 134 executed on the developer computing device 110. The test execution engine 154 may be instrumented, such as by including an additional tracer application to capture additional telemetry data associated with the execution of the script in the test execution engine 154. In some examples, the script may be a puppeteer script that mimics user actions in an additional instance of web application 134 executed on the developer computing device 110. The additional instance of web application 134 may include an additional tracer application to capture additional telemetry data associated with the executed script.

Span generator 156 is a program used to generate a representation of a span hierarchy associated with the telemetry data measured from the execution of the script on the test execution engine 154. Similar to the telemetry tree builder 151, the representation may include a text file of the span hierarchy, such as a JSON file, or may also be a graphical representation of the span hierarchy, such as a tree plot of the span hierarchy with spans represented by nodes of the plot. The spans of the span hierarchy may also include attributes such as the attributes described in the description of the telemetry tree builder 151. In some examples, the span generator 156 and the telemetry tree builder 151 may be combined into a single program or component.

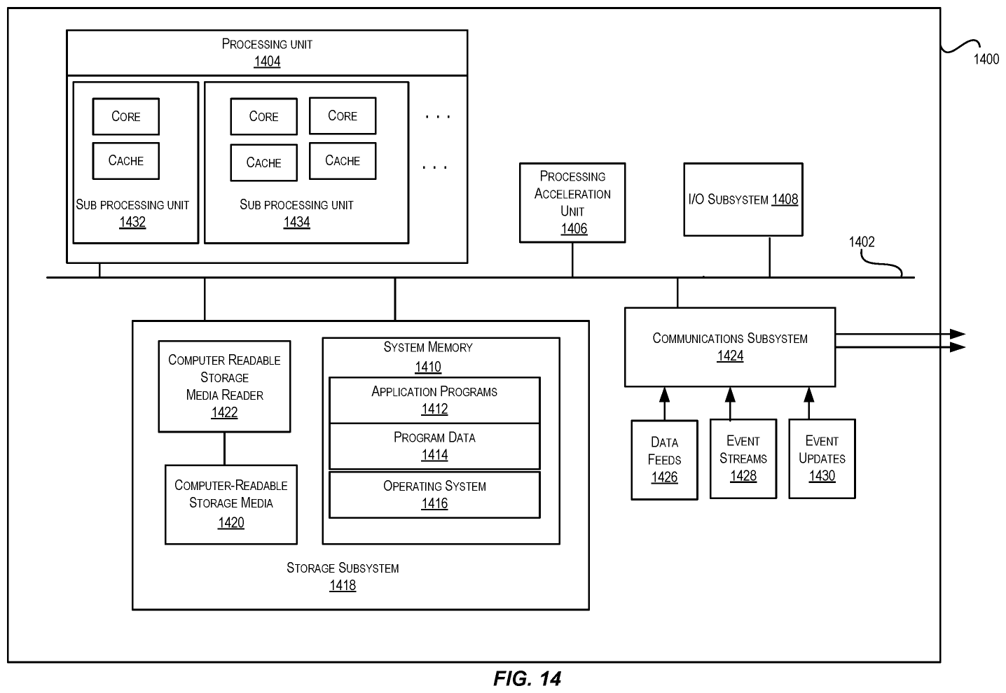

Span comparator 158 compares the span hierarchy associated with the user telemetry data 122 and the span hierarchy associated with the executed script to identify differences such as identifying missing and added spans, spans in a different order and sequence within the span hierarchy, and differences in the various attributes of the spans and nodes of the span hierarchy. When the span comparator 158 determines that the span hierarchy associated with the user telemetry data 122 and the span hierarchy associated with the executed script match within a predetermined threshold, the span comparator 158 may generate a textual or graphical report of the differences. Additional description of the textual or graphical report is provided in the description of FIG. 14.

Servers 140a-n can be configured to perform identical, similar, or different functions. For example, servers 140a-n can operate as a distributed server system. In another example, servers 140a-n can be web-servers, file servers, or other servers that serve one or more components from web pages or can receive database queries and provide results. In some cases, servers 140a-n can be under the control of different entities (companies or individuals) and/or at different locations. Accordingly, certain aspects described herein relate to obtaining telemetry data across different servers via span context propagation. Developer computing device 110, end user computing device 140, network 150, and servers 140a-n can be connected across one or more connections such as network 150. Examples of network 150 include wired networks, wireless networks, and the Internet.

End user computing device 130 includes web application 134 (e.g., a web page), web browser 132, and tracer application 136. Web application 134 can be rendered by web browser 132. Tracer application 136, which can be part of web application 134, provides instrumentation capabilities. For instance, tracer application 136 collects telemetry data, which can be exported to an external device periodically or on-demand. Examples of telemetry data include how often certain features are used, measurements of start-up time or execution time, whether a process crashed, failure information, and user types.

In an example, a software developer builds a custom web-based application using developer IDE 112 and back-end developer tools 114. In particular, software tools running on developer computing device 110 insert code (e.g., tracer code) that provides telemetry capability, generating instrumented user application 120. In some cases, instrumented user application 120 can be sent directly from developer computing device 110 to end user computing device 140. In other cases, instrumented user application 120 is sent directly to a server 140a-n, where instrumented user application 120 is hosted and later downloaded by end user computing device 140.

End user computing device 140 accesses the application, for example, from server 140a across network 150. A user operating the end user computing device 140 interacts with the application, which causes the end user computing device 140 to access one or more of servers 140a-n, which, in turn, serve all or part of the application to the end user computing device 140. End user computing device 140 executes the telemetry functionality, which causes operations caused directly by user interactions with the application (e.g., clicks, reloads) or indirectly (e.g., images linked from a page to be loaded, etc.) to be instrumented. In this manner, more detailed telemetry information is available than with previous solutions. The user telemetry data 122 is gathered by one or more servers 140a-n.

As discussed, certain aspects relate to obtaining telemetry information from enterprise applications. To facilitate telemetry, within an enterprise application, one or more spans are created. As used herein, a span refers to a set of named operations that represent a unit of work. A particular span can refer to a process. A span has a span context. As used herein, a span context can include a trace identifier and a span identifier. Accordingly, a first process can have a first span and a second process a second span. If the second process is called by the first process, then the first and second spans are related by a parent-child relationship such that the first span is a parent and the second is a child. Tracking the spans of different processes facilitates a more detailed instrumentation.

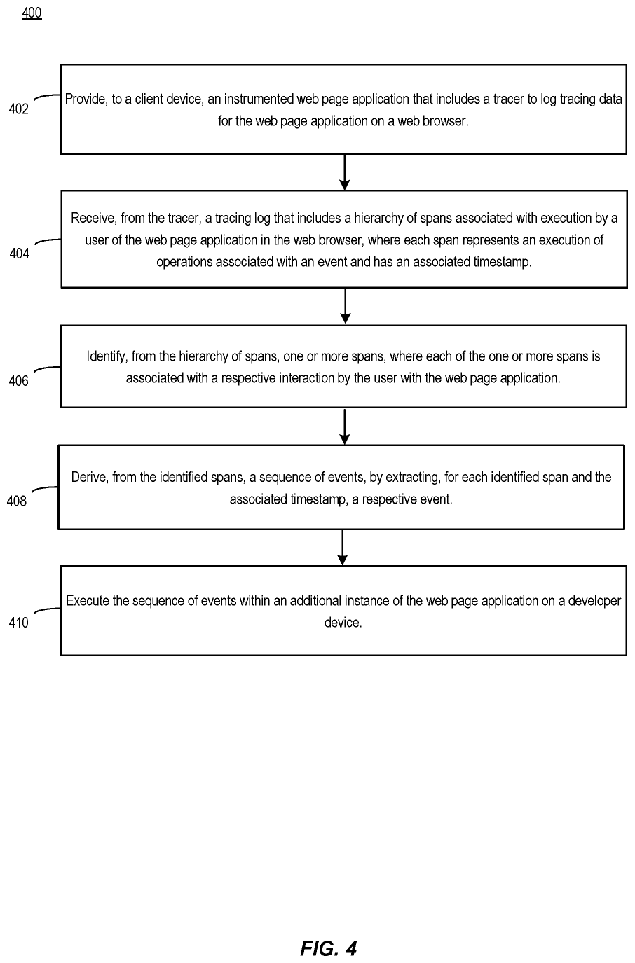

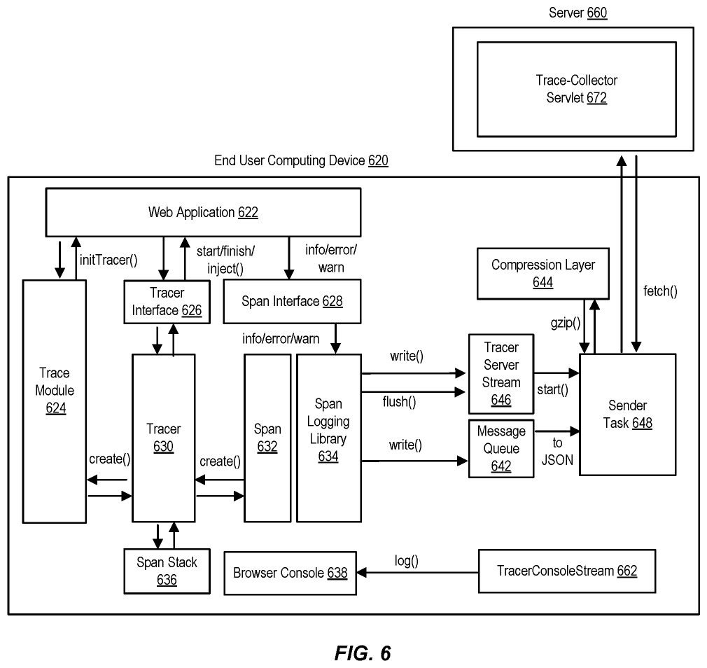

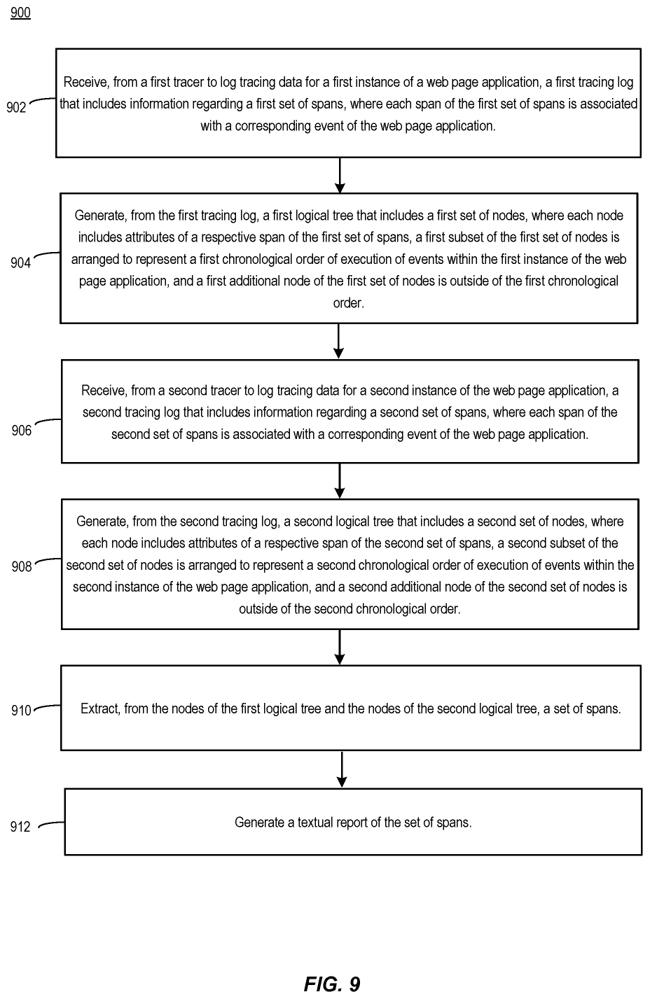

Certain figures and associated description further explain certain aspects. For instance, FIGS. 4-5 relate to different aspects of span instrumentation. FIGS. 6-8 relate to prioritization of various spans during instrumentation. FIGS. 9-14 relate to error detection and error reporting. FIGS. 15-17 illustrate various computing systems which can implement instrumentation functionality.

### Instrumentation of Web-Based Enterprise Applications

FIG. 2 depicts an example of a method 200 used to gather telemetry data, according to an aspect of the present disclosure. Method 200 can be performed by one or more of developer computing device 110 and servers 140a-n.

At block 202, method 200 involves providing a web page application to a web browser on a client device. For instance, server 140a serves web application 134 to web browser 132. Web application 134 includes tracer application 136, which provides instrumentation. Web application 134 instrumented with tracer application 136 prior to method 200.

At block 204, method 200 involves detecting a start of the web page application. Web browser 132 begins executing web application 134 and tracer application 136. Server 140a can detect the start of the execution by determining that web browser 132 has requested one or more resources.

At block 206, method 200 involves instantiating, based on a start of the web page application, the tracer application. Tracer application 136 is configured to log tracing data for web application 134.

At block 208, method 200 involves detecting an event initiated by interaction with the web page application. Web application 134 continues to execute and an event is triggered. Examples of events include user interface interactions, clicks, navigations, mouse-overs, refreshes, etc. Additionally, an event can be representational state transfer (REST).

At block 210, method 200 involves automatically logging a start of a span based on the detection, the logging associating the span with the tracer application. Tracer application 136 causes the logging of a span that corresponds to the event.

At block 212, method 200 involves executing operations corresponding to the event. Web browser 132 executes code corresponding to the event, such as loading an image or resource.

At block 214, method 200 involves automatically logging an end of the span based upon a completion of the operations corresponding to the event. Upon the completion of the code referred to in block 212, tracer application 136 logs the end of the span. Data collected can include processing cycles used, time taken to execute the span, memory consumption, and so forth.

As discussed herein, certain aspects can measure data relating to a span that crosses multiple servers, processing threads, or uses multiple separately identifiable operations. For instance, an execution of block 210 can result in additional spans, each providing more granular information, being created. For instance, the tracer application 136 can create a first child span corresponding to a first operation and a second child span corresponding to a second operation. The first and second child spans can be children of the span.

Continuing the example, tracer application 136 automatically logs an end of the first child span based on completion of the first operation and automatically logs an end of the first child span based on completion of the first operation. Therefore, the tracer application 136 obtains more granular information than just the span alone. The first child span and the second child span are associated with the span.

An example below shows code for an insertion of a client-side span context using Javascript:

```
define([“@oracle/trace-client/trace”,
    “@oracle/trace-client/trace_utils”],
      (Trace, TraceUtils) => {
    //Create a tracer
    const tracer = Trace.initTracer({
        url: getCollectorUrl( ) //Domain-specific
    });
    //Create a root span
    tracer.span({
      operationName: “rootSpan”
    }, (span) => {
          //Log a simple message
          rootSpan.info(“Here's a message”);
          //Log a message with custom fields
          rootSpan.info({messageStatus: ‘lit’}, “This message is
lit.”);
          //Create a child span (if desired)
          tracer.span({
            operationName: “childSpan2”,
          }, (childSpan) => {
          //Create a fetch request
          let request = new
Request(“http://.../myService/endpoint”);
          //Inject the child span's context
          request = tracer.inject(childSpan, request);
          //Make the fetch call
          fetch(request).then((response) => {
              // ... process the response
              // Close the child span
                childSpan.finish( );
              });
          }); // end child
          //Close up root span when we're done
          rootSpan.finish( );
        }); //end root
      }); //end process response
  }); //end define
```

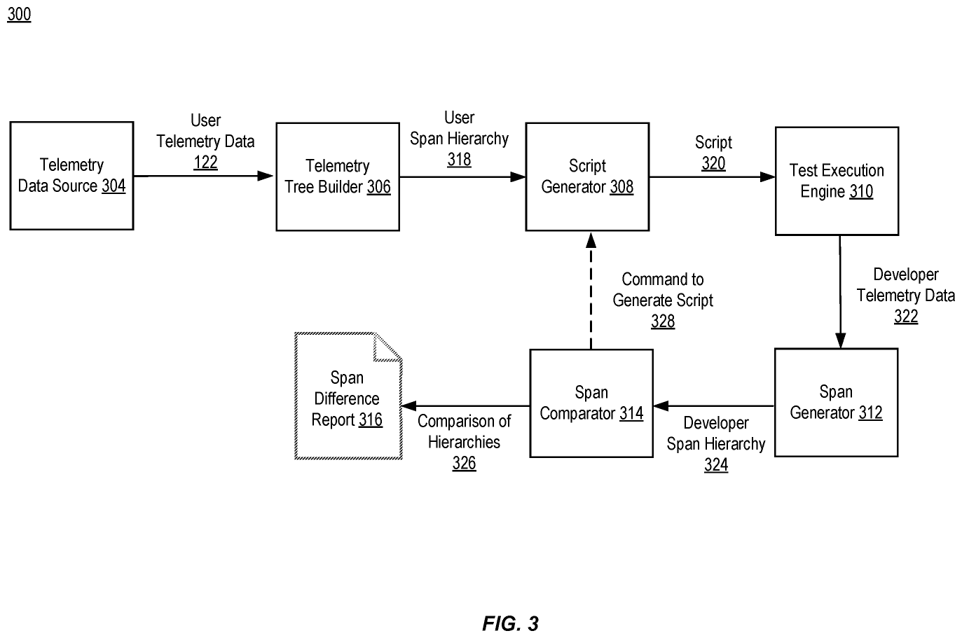

FIG. 3 depicts an example of a block diagram of the test environment generation architecture 300, according to certain aspects of the disclosure. The block diagram includes a telemetry data source 304, telemetry tree builder 306, script generator 308, test execution engine 310, span generator 312, span comparator 314, and the span difference report 316 produced by the span comparator 314. The block diagram further shows the outputs and inputs of the various blocks, including user telemetry data 122 from FIG. 1, user span hierarchy 318, script 320, developer telemetry data 322, developer span hierarchy 324, comparison of hierarchies 326, and a command 328 to generate a new script. Further description of the individual components is provided in the description of FIG. 1.

The telemetry data source 304 may include a telemetry database or a tracer application. The telemetry data source 304 may include a query engine by which components such as the telemetry tree builder 306 may query the user telemetry data 122. The telemetry data source transmits user telemetry data 122 to the telemetry tree builder 306 and is further described in FIG. 1.

The telemetry tree builder 306 generates a representation of the user telemetry data 122 such as a representation of a user span hierarchy 318 associated with the user telemetry data 122 from the telemetry data source 304. In some examples, the representation of the user span hierarchy 318 may be a Span JSON file representing one or more user span hierarchies 318 of the user telemetry data 122. The telemetry tree builder 306 may query user telemetry data 122 from the telemetry data source 304 according to the query engine. In some examples, the telemetry tree builder 306 may query user telemetry data 122 in response to an error reported by a user or an error detected by the telemetry data source 304. For example, the telemetry data source 304 may include a database of user telemetry data 122 from multiple users. The telemetry data source 304 may detect an error when user telemetry data 122 deviates from other telemetry data stored in the database, such as when a span's duration is outside of a predetermined range or exceeds other spans associated with the same or similar events and operations by a predetermined period of time. In some examples, the telemetry data source 304 may include a tracer application and may detect an error when it measures a span associated with an error.

One example of a JSON file generated by the telemetry tree builder 306:

[{‘attributes’:{
‘event’:‘navigation’,
‘http.url’:‘https://foo.oracle.com/myapp’, // ...other fields
},‘childNodes:{//...}},
{‘attributes’:{
‘event’:‘componentEvent’
‘trigger.type’:‘click’,
‘trigger.target’:‘#myElement’,
‘trigger.tag_name:‘OJ-BUTTON’, // ...other fields
},‘childNodes’:{//...}}
]

Script generator 308 receives the representation of the user span hierarchy 318 from the telemetry tree builder 306, and generates a set of instructions (e.g., a script 320) of user actions based on attributes of the user span hierarchy 318. The script generator 308 may include pluggable output modules for outputting the script 320 in different formats suitable for execution.

The following shows a sample conversion from Span JSON file format to a test script in WebDriverIO format:

var url = ’https://foo.oracle.com/sample_app’;
await browser.url(url); // WebdriverIO supports Xpath, other
formats may use CSS selectors
let 16et = await $(‘//OJ-BUTTON[@id=”myElement”]’);
await 16et.waitForExist({ enabled: true, timeout: 30000 });
await 17et.click( );

One example of an algorithm used by the script generator 308 to generate a script 320 may include:

If name=“navigation”, emit a navigation snippet to the specified URL. The URL should be parameterized for easy replacement for running the test script on a different environment
If name=“componentEvent” or otherwise indicates a user-generated action, emit an event snippet using the trigger.* fields to identify the component with which to interact.
If name=“metric/heroRendered”, add a wait for the element to appear on the page.
If name=“metric/heroReady”, add a wait on the specified element's BusyContext when the application includes a JavaScript Extension Toolkit (JET applications)

The test execution engine 310 receives the script 320 from the script generator 308 and executes the script 320. The test execution engine 310 may include an additional instance of an application associated with the user telemetry data 122 received from the telemetry data source 304. The execution of the script 320 in the test execution engine 310 produces developer telemetry data 322 that is used by the span generator 312 to generate a representation of one or more developer span hierarchies 324 associated with the developer telemetry data 322. The span generator 312 may use the techniques of the telemetry tree builder 306 to produce a Span JSON file, or other textual and graphical representations of the one or more developer span hierarchies 324.

The span comparator 314 compares the user span hierarchies 318 associated with user telemetry data 122 from telemetry data source 304 and the developer span hierarchies 324 associated with developer telemetry data 322 from the executed script and identifies differences and similarities between the span hierarchies. The span comparator 314 identifies differences such as identifying missing and added spans, spans in a different order and sequence within the span hierarchy, and differences in the various attributes of the spans and nodes of the span hierarchy. The span comparator 314 may generate a span difference report 316 by outputting a comparison of hierarchies 326 to an editable template and may include a textual report of the differences and errors in the span hierarchies.

In some examples, when the user span hierarchies 318 associated with the user telemetry data 122 from telemetry data source 304 and the developer span hierarchies 324 associated with developer telemetry data 322 from the executed script differences exceed a predetermined threshold, the span comparator 314 may transmit a command 328 to the script generator 308 to generate another script 320 until the differences between the user span hierarchies 318 and the developer span hierarchies 324 fall within the predetermined threshold.

### Method for Generating a Test Environment

FIG. 4 depicts an example of a method 400 for generating a test environment from a user's telemetry data, according to certain aspects of the disclosure.

It should be appreciated that method 400 provides a particular method to generate a test environment from a user's telemetry data. Other sequences of operations may also be performed according to alternative examples. For example, alternative examples may perform the operations outlined below in a different order. Moreover, the individual operations illustrated by method 400 may include multiple sub-operations that may be performed in various sequences as appropriate to the individual operation. Furthermore, additional operations may be added or removed depending on the particular applications. Further, the operations described in method 400 may be performed by different devices.

At block 402, method 400 involves providing, to a client device, an instrumented web page application that includes a tracer to log tracing data for the web page application executing on a web browser. The web page application may communicate with a tracer application, such as the tracer application 136 of FIG. 1, to log tracing data for the web page application on a web browser. The tracer application 136 may be configured to log tracing data associated with events or navigations, such as user actions, or buffering of prioritized elements.

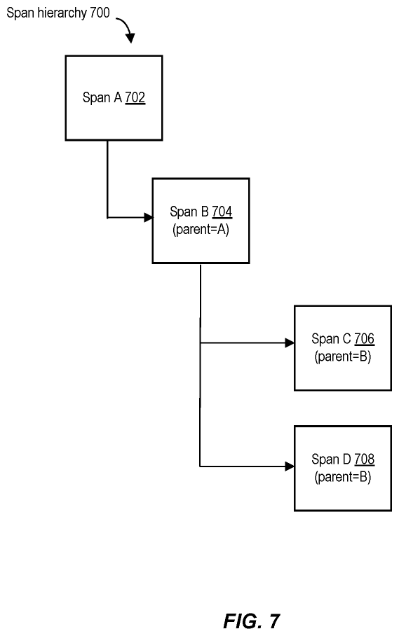

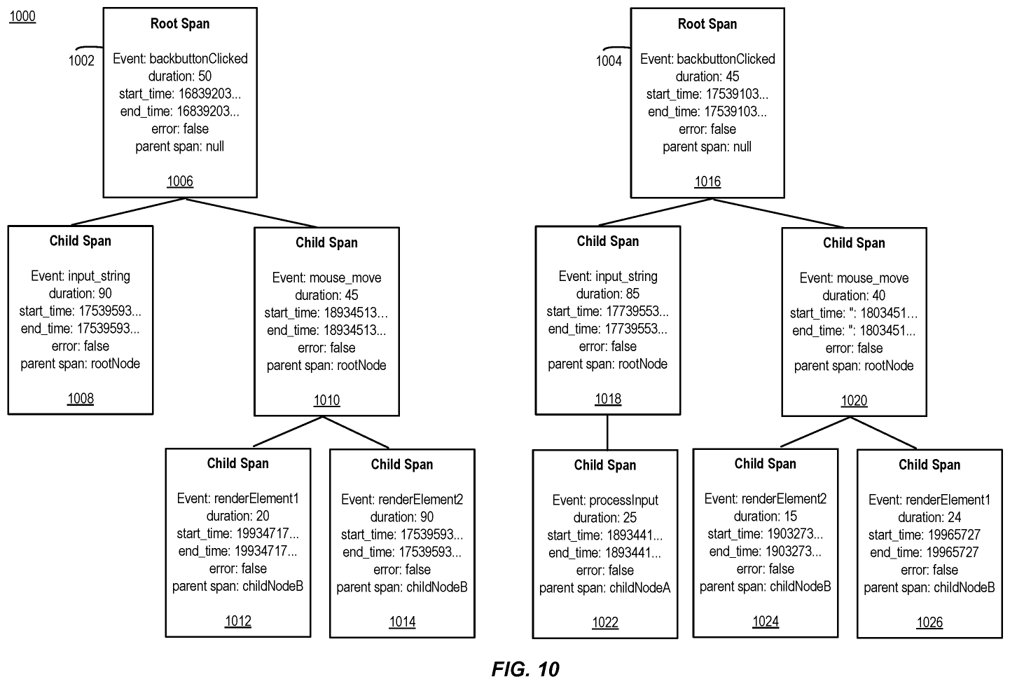

At block 404, the method 400 involves receiving, from the tracer, a tracing log that includes a hierarchy of spans associated with execution by a user of the web page application in the web browser, where each span represents an execution of operations associated with an 30) event and has an associated timestamp. In some examples, the hierarchy of spans may be received from another data source such as a database of tracing data. The spans from the span hierarchy may represent an execution of operations associated with an event and may have associated attributes such as a timestamp. FIG. 7 and FIG. 10 further describe span hierarchies.

At block 406, the method 400 involves identifying from the hierarchy of spans, one or more spans, where each of the one or more spans is associated with a respective interaction by the user with the web page application. In some examples, identifying the one or more spans may include determining an association for the one or more spans.

The association can be include one or more of a reference to an element associated with an interaction of the user with the web page application, a navigation by the user on the web page application, or a priority designation. In some examples, the telemetry tree builder 151 of FIG. 1 may be used to determine associations between the spans of the hierarchy of spans.

At block 408, the method 400 involves deriving from the identified spans, a sequence of events, by extracting, for each identified span and the associated timestamp, a respective event. The script generator 152 of FIG. 1 may derive the sequence of events and generate a set of instructions (e.g., a script) for execution at block 410.

At block 410, the method 400 involves executing the sequence of events on an additional instance of the web page application on a developer device. In FIG. 1, the execution of the sequence of events may occur at the test execution engine 154, which may simulate the web page application or include an additional instance of the web application 134.

In some examples, identifying the one or more spans in method 400 involves determining an association, for the one or more spans, with one or more of a reference to an element of a respective interaction by the user on the web page application, a navigation by the user on the web page application, and a priority designation.

In some examples, method 400 involves detecting, from the hierarchy of spans of the tracing log, an error associated with the instrumented web page application. The error can be detected from one or more of: a span associated with an error in the execution of one or more operations: a span with a duration of time greater than a predetermined threshold; and an error report from the user.

In further examples, receiving the hierarchy of spans from the tracer is triggered by the detection of the error. In some examples, the error is detected by the tracer, such as the tracer application 136 of FIG. 1. In further examples a database or server, such as server 140a of FIG. 1, may identify the error and transmit the user telemetry data 122 to the developer computing device 110 in response to or based on the error.

In some examples, the additional instance of the web page application on the developer device from block 410 may include an additional tracer to log additional tracing data for the additional instance of the web page application.

The method 400 may involve receiving an additional tracing log including an additional hierarchy of spans associated with execution of the additional instance of the web page application, where each span of the additional hierarchy represents an execution of operations associated with an event and has an associated timestamp. The method 400 may further involve identifying one or more differences comparing the execution of operations of the tracing log with the execution of operations of the additional tracing log to identify differences between the operations and when the differences between the tracing log and additional tracing log exceeds a predetermined threshold, may involve deriving an additional sequence of events.

In some examples, deriving the sequence of events includes generating a script, where the script includes a list of operations for execution within the additional instance of the web page application.

FIG. 5 depicts an example of an instrumented application for generating span context, according to certain aspects of the disclosure. The instrumented application can be built and instrumented by a software development tool such as developer IDE 112 and may be executed a browser executing on a computing device. FIG. 5 depicts web application environment 500, which includes web application 502, server 540, query 560, and a response 552. In the example depicted in FIG. 5, web application 502, which is instrumented with tracer capabilities executes on a web browser, communicating with server 540 to serve one or more web pages. Web application 502 sends one or more queries 560 and receives in response, one or more responses 552. While FIG. 5 is described with regard to a web page, it should be appreciated that the flow and components can be executed by a mobile application, or other application.

Web application 502 shows a flow 510, which includes web page 512 having components 514, 516, and 518. The components can be mobile applications, web applications, service connections, business objects, or processes. Each component can perform different functionality such as part of a web page. Each of components 514, 516, and 518 can cause component events 515, 517, and 519 respectively. Each of component events 515, 517, and 519 trigger one or more occurrences in the telemetry runtime 520, which in turn causes one more actions to be performed, while logging the events.

Modules of a flow 510 or a web page 512 may interact or relate to each other. For instance, for a particular web page, the components may be user interface (UI) components, variables, action chains, web page flows, and page navigation, and data access through REST endpoints. Variables can be a mechanism used to store and manage a state of the browser settings, client device settings, user settings or other parameters. The components of the web page can interact with a telemetry runtime that processes various events for each component.

The telemetry runtime 520 can generate actions or action changes that correspond to component events 515, 517, and 519. For example, a user may click on a particular visual element of the web page displayed within the browser, causing a component event. The telemetry runtime 520 may determine that the web browser should navigate to a new web page 550. The telemetry runtime 520 may determine that the action associated with the user click is to update a portion of a user interface (UI) of the web page 512.

In another example, the telemetry runtime 520 may initiate an action chain 554 that corresponds to the steps to update the portion of the UI. For instance, an action chain may be a set of one or more individual actions that are related or sequential actions 556. Each action chain can be triggered by an event. For example, a user click can trigger navigation to a page that corresponds to the location on the browser that the user click was received (e.g., a hyperlink, a navigation button, etc.). An action chain can define input parameters and local variables that are available within the scope of that action chain and can include application-scoped parameters and variables. The telemetry runtime may determine that one or more REST calls 558 to the server are needed to update the portion of the UI.

In response to REST call 558, web application 502 sends a query 560 to a REST service endpoint 542 of server 540. The query 560 can include an injection span context. In return, the server 540) sends back a response 552, which can include additional HTTP headers. The web application 502 then uses the response to complete the actions caused by the component event(s).

Flows of a web page and page navigation govern the communication of information between a first page to a second page. Each web page has a predefined lifecycle, as does each application that is running in the browser. Each lifecycle event, such as entry or exit from a page, can provide a trigger for an action chain. All data entering a mobile or web application may be based on REST protocols. This data can come from custom business objects and from business objects provided by service connections. Actions and variables control how data is sent to and from a REST endpoint in a mobile or web application. Action chains have a well-defined context and contract: an action chain orchestrates its underlying actions, coordinating state flow and the execution path. The action chain can define input parameters and local variables that are only available in that context. An example of an action chain is one that makes a REST call (first action), then takes the result of that and stores that in a variable (second action). Actions may export a new state to that context, but it is only available to future actions along that same action chain. An action chain can be created in the context of a page or the application and exists within the scope of the page or the application. It has a defined interface and contract and can be called by event triggers using its ID.

A telemetry Application Programmer Interface (API) 522 can enable programmer access to the activities of the telemetry runtime, any actions or action chains, component events, and other related activities (e.g., a server response to an action). The telemetry API 522 can output span logs to a database, storage medium, or another server or browser for additional processing. In one example, the telemetry API may be a REST API. The telemetry API 522 can store cloud infrastructure objects such as audit logs, application flow logs, or other log files. The telemetry API 522 may periodically sample the stored cloud infrastructure objects to output telemetry data to common analytics ingestion 524 or a client log ingestion endpoint 526.

Common analytics ingestion 524 may ingest log data from telemetry API 522. In one example, the common analytics ingestion 524 can ingest log data from cloud infrastructure object storage using a REST API. In one example, the common analytics ingestion 524 may determine storage locations for the collected log data. The common analytics ingestion 524 can ingest various log data at a user, group, or organization level. In some examples, common analytics ingestion 524 can transform the log data into a visualization for an analytics console.

A client log ingestion endpoint 526 can also be configured to receive log data from the telemetry API 522. The client log ingestion endpoint 526 can store log data, transform log data into various visualizations, or perform additional processing to log data.

Generally, distributed tracing may be implemented using a Trace-Client API within the distributed tracing architecture. The Trace-Client API consists of a tracer which is used to create spans around operations within an application. Spans can have child spans that indicate smaller granularity operations of the respective parent span, which can, in turn, have children that indicate smaller granularity operations than the first child span. A set of spans emanating from a single parent may be considered a trace. Spans contain metadata about the operation they are measuring, along with some identifying information and other attributes as discussed in the description of FIG. 1. For applications with operations that make out-of-process calls (for example, a client application making a call to a REST service), span context can be propagated along with the outgoing request (for example, in the form of special HTTP headers). The receiving application or server can extract the span context and use it to create child spans of the parent span on the client. The Trace-Client API has the ability to output span information in the form of log messages (one each for the beginning and end of spans) to various backend servers.

An example of application spans is a simple application flow. For instance, a user navigates to a web page and click a button. The button click triggers an event, which causes the application to call an event handler. The event handler makes a REST (define) request, which is processed by a REST service. The service returns a response, which causes the user interface of the application to be updated.

FIG. 6 depicts tracer components within an instrumented application that are used to generate span context and logs, according to certain aspects of the disclosure. In the example depicted in FIG. 6, end user computing device 620, which executes web application 622, communicates with server 660 via various commands and/or API calls. Web application 622 can be developed by developer IDE 112 and can be customer-developed software. Code to support instrumentation is automatically added by developer IDE 112.

End user computing device 620 includes one or more modules such as web application 622 (or any other consuming client), trace module 624, tracer interface 626, span interface 628, tracer 630), span 632, a span logging library 634 (i.e., a Bunyan Logger), span stack 636, browser console 638, compression layer 644, tracer server stream 646, sender task 648, message queue 642, and tracer console stream 662. In turn, tracer 630 operates to perform instrumentation on web application and creates one or more spans 632 and adds active spans to span stack 636. Server 660 includes one or more modules such as a trace-collector servlet 672.

Subsequently, web application 622 receives or detects interactions from the user (e.g., a user click). Web application 622 interacts with trace module 624 and/or tracer interface 626 to start one or more tracers 630. In turn, span logging library 634 logs information and metadata such as an event type, name of the event, URL of a server request, status code of the return value, errors, warnings, and so forth via span interface 628.

Various API calls are available. The API call initTracer( ) initializes and returns a global tracer object. The API call initTracer is called once for an application context and returns a TracerOptions object. The API call activeTracer returns the global tracer object. For example, The API call inject( ) causes a span to be injected into a request (e.g., to a server). Upon return the API call extract( ) can be used to extract a span.

Multiple spans can be generated. For instance, tracer 630 can create a span to represent an event or a thread of the web application 622. Tracer 630 can create child spans as appropriate based on the particular operation for which the tracer created the span. As discussed further herein, instrumented applications can obtain information from different threads and/or different servers that service requests caused by the triggering of events in the application.

Web application 622 may use tracer interface 626 to control the tracer or receive injections for the span. The tracer may also monitor, write, or read to span stack 636 where one or more spans can be cached or accessed by the tracer to monitor parent spans, or insert span context within a newly created span such as span 632. Web application 622 may use span interface 628 to communicate span related information to a span logging library 634. Compression layer 644 can compress span related information minimization before it is sent to the trace-collector servlet 672. Examples of compression techniques used by compression layer 644 include zip and gzip. In one example, the tracer console stream 662 may output a stream of the span log to a browser console presented on the end user computing device 140. In turn, server 660 may execute a trace-collector servlet 672, which stream of span logs and collects traces from sender task 648 on end user computing device 620.

FIG. 7 depicts an example of a span hierarchy, according to certain aspects of the disclosure. In span hierarchy 700, span A 702 is a parent span of span B 704. In turn, span B 704 is a parent span of span C 706, and span D 708. In span hierarchy 700, data for all spans, span A 702, span B 704, span C 706, and span D 708 is gathered.

Span hierarchy 700 describes a set of relationships between various spans in the span context. Within span hierarchy 700, relationships exist between parent and child spans. As depicted, span hierarchy 700 represents a hierarchy of events such as user click, event handler, REST request, process response, server process request, or update UI. Span hierarchy 700 includes span A 702, span B 704, span C 706, and span D 708.

In an example, web browser 132 receives user click represented by span A 702. The user click represented by span A 702 results in the creation of span B 704. In response, web browser 132 initiates an event represented by the action of the user click, which triggers the operation of event handler represented by span B 704. The web browser 132 may use event handler to determine one or more actions to take responsive to what event is detected based on the user click that was received. The instantiation of event handler causes span B 704, which is a child span of span A 702.

Continuing the example, event handler represented by span B 704 may also cause a REST request represented by span C 706 and a process response represented by span D 708. Because processing the response of the REST request occurs after the REST itself, span C 706 (corresponding to the REST request) occurs before span D 708. The REST request causes a server to process the request. The processing of the REST response causes the user interface (UI) to be updated accordingly.

### Telemetry Tree Builder

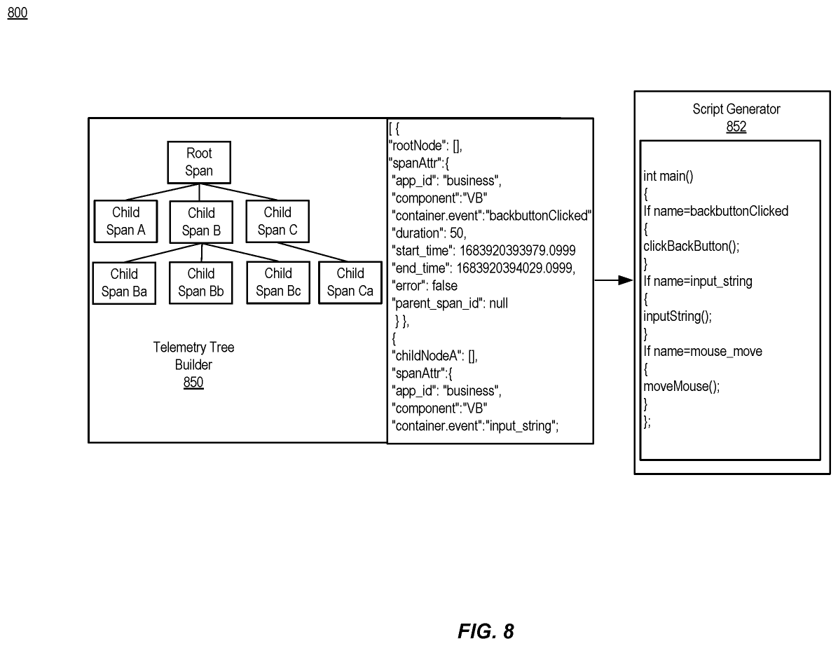

FIG. 8 depicts a simplified representation 800 of a telemetry tree builder 850 and script generator 852, according to certain aspects of the disclosure. In some examples, as shown in FIG. 1, the telemetry tree builder 850 and script generator 852 may be executed on a developer computing device. Telemetry tree builder 850 demonstrates a graphical representation of a span hierarchy, and a textual representation of a span hierarchy. The script generator 852 generates a set of instructions (e.g., a script) based on the span hierarchy from the telemetry tree builder 850. The script generator 852 generates the script based on attributes of spans from the span hierarchy. For example, spans of the span hierarchy may include an attribute, such as “container.event”, associated with a particular event or operations associated with an event. By way of example, the root node of FIG. 8 is associated with an event “backbuttonClicked” which is associated with a user clicking a back button of a web application. The script generator may determine the event associated with the root node based on the attribute and generate a script including clicking the back button.

FIG. 9 depicts an example of a method 900 for error detection within telemetry data, according to certain aspects of the disclosure.

At block 902, the method includes receiving, from a first tracer to log tracing data for a first instance of a web page application, a first tracing log that includes information regarding a first set of spans, where each span of the first set of spans is associated with a corresponding event of the web page application. The first tracing log may be associated with a first instance of an application such as a web page application. The first tracing log may also include information regarding a first set of spans. The spans may be associated with a corresponding event of the application. For example, the telemetry data may be associated with the rendering of an element or a user interaction and input. FIG. 1 shows a tracer application 136 which may include a tracing log.

At block 904, the method includes generating, from the first tracing log, a first logical tree that includes a first set of nodes, where each node includes attributes of a respective span of the first set of spans, a first subset of the first set of nodes is arranged to represent a first chronological order of execution of events within the first instance of the web page application, and a first additional node of the first set of nodes is outside of the first chronological order. The nodes of the first logical tree may include attributes of a respective span of the first set of spans. One or more of the spans may be executed asynchronously from other spans and may be represented in the first logical tree as being outside of the first chronological order. In FIG. 1, the generation of the first logical tree may occur using the telemetry tree builder 151.

At block 906, the method includes receiving, from a second tracer to log tracing data for a second instance of the web page application, a second tracing log that includes information regarding a second set of spans, where each span of the second set of spans is associated with a corresponding event of the web page application. The second tracing log may be associated with a second instance of the application and may include information regarding a second set of spans associated with corresponding events of the application. The second instance of the application may occur using the test execution engine 154 on developer computing device 110 of FIG. 1.

At block 908, the method includes generating, from the second tracing log, a second logical tree that includes a second set of nodes, where each node includes attributes of a respective span of the second set of spans, a second subset of the second set of nodes is arranged to represent a second chronological order of execution of events within the second instance of the web page application, and a second additional node of the second set of nodes is outside of the second chronological order. The nodes of the second logical tree may include attributes of a respective span of the second set of spans. FIGS. 7 and 10 further describe attributes of the span hierarchies. The second logical tree may be arranged to represent a second chronological order of execution of events within the second instance of the application. Some of the spans may be executed asynchronously from other spans and may be represented in the second logical tree as being outside of the second chronological order.

At block 910, the method includes extracting, from the nodes of the first logical tree and the nodes of the second logical tree, a set of spans. As discussed below, various approaches can be used to extract the spans.

In a first example, extracting may include identifying a correspondence between a first node in the first logical tree and a second node in the second logical tree. Correspondences may include the nodes being associated with the same type of span, such as a span associated with the rendering of an element, or a span associated with a user interaction, such as a user clicking a button on the web page application.

Extracting further may include identifying a first difference between a first attribute of the first node and a second attribute of the second node. Differences between the first attribute of the first node and the second attribute of the second node may include differences in length of time (e.g., span duration) for the execution of a span associated with the node. For example, a span associated with the first node may identify nodes associated with spans persisting a length of time greater than a predetermined threshold. Because spans of the same type may persist over different lengths of time because of differences in connectivity to a network, different computational speeds, or differences in optimization of the web page application for a particular browser or device, the method 900 may filter differences in lengths of time that fall outside of a predetermined threshold difference. Differences in the attributes may further include differences between the type of span associated with the node, including the event associated with the span and whether the span is associated with a user interaction such a user navigation or other input.

In a second example, identifying a set of common nodes between the first subset of the first set of nodes and the second subset of the second set of nodes includes comparing the parent nodes and child nodes of nodes of the first logical tree and the second logical tree based on the type of spans associated with the nodes. For example, the first logical tree may include a root node, a first child node, and a second child node representing spans associated with a first set of events, and the second logical tree may include a root node, a first child node, and a second child node representing spans associated with a second set of events that correspond to the same type of event as the first logical tree. For example, the nodes may correspond to the same type of event (e.g., a user clicking a button) on different instances of an application.

In a third example, identifying a second difference between the first chronological order and the second order may include comparing node lineages or execution times of the first logical tree and the second logical tree. For example, the first logical tree, and the second logical tree may include a nodes representing spans executed in different orders. In some examples, the spans may execute asynchronously, or persist longer than expected which changes the chronological order of the spans and extracting one or more spans based on the correspondence of nodes and differences. For example, as further described in FIG. 10, FIG. 10 shows child spans 1010, 1012, and 1014 executed in a different order than child spans 1020, 1024, and 1026. In some examples, the method includes identifying significant differences. The method may include prioritizing attributes when identifying differences and ignore differences in other attributes. For example, the method may identify differences in length of time of a span when the length falls outside of predetermined threshold, but otherwise ignore differences in length of time of spans when within the predetermined threshold.

The above approaches may be used in combination with each other and in different orders.

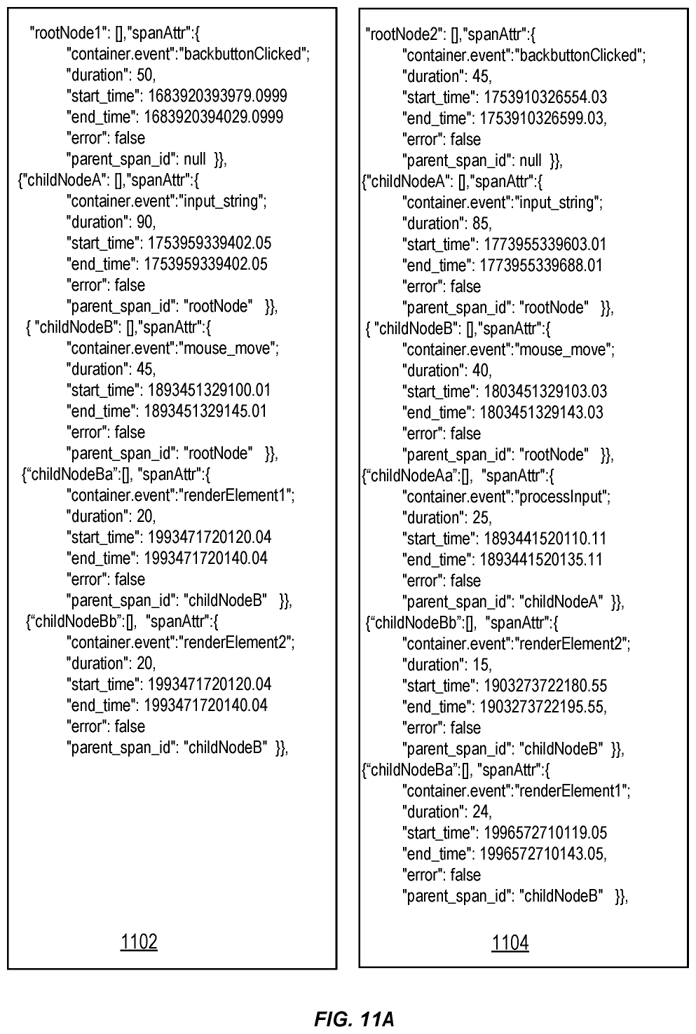

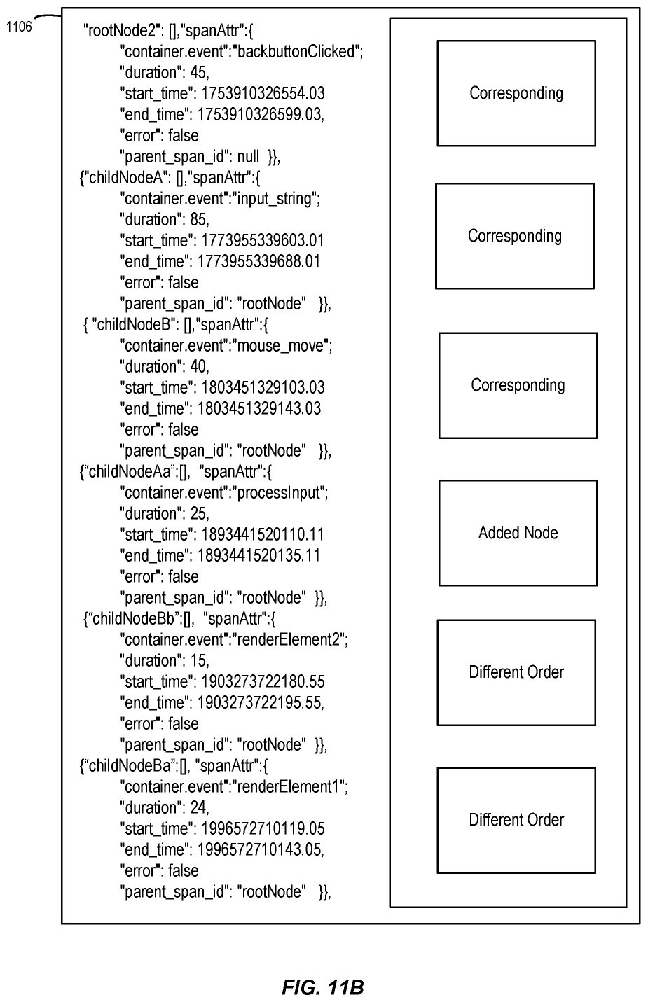

At block 912, the method includes generating a textual report of the set of spans. The textual report may include highlighting of spans that include differences or are in a different order. For example, the textual report may include a textual representation of the first set of spans and the second set with corresponding spans highlighted in green, missing spans and spans with errors or differences highlighted in red, and spans in a different chronological order highlighted in yellow. FIGS. 11A and 11B further describes the textual report.

FIG. 10 depicts an example of a comparison 1000 of span hierarchies, according to certain aspects of the disclosure. Comparison 1000 includes first span hierarchy 1002 and second span hierarchy 1004. The first span hierarchy 1002 represents a span hierarchy including root span 1006 and child spans 1008, 1010, 1012, 1014 associated with operations executed on a first device, such as the end user computing device 130 of FIG. 1. The second span hierarchy 1004 represents a span hierarchy including root span 1016 and child spans 1018, 1020, 1022, 1024, 1026 associated with operations executed on a second device, such as the developer computing device 110 of FIG. 1. The second span hierarchy 1004 includes an additional span represented by child span 1022 and spans in a different order from the first span hierarchy 1002.

FIGS. 11A and 11B illustrate differences between the first span hierarchy 1002 and second span hierarchy 1004 of FIG. 10. FIG. 11A illustrates a textual report of the first span hierarchy 1102 and a textual report of the second span hierarchy 1104. The textual report of the second span hierarchy 1104 includes additional “childNodeAa” representing child span 1022 of the second span hierarchy 1004 of FIG. 10. The nodes for child span 1024 and child span 1026 are in a different order in the textual report of the second span hierarchy 1104 as also shown in FIG. 10.

FIG. 11B illustrates the differences between the first span hierarchy 1002 and second span hierarchy 1004 of FIG. 10 in a textual report 1106. The textual report 1106 highlights correspondences and differences between first span hierarchy 1002 and the second span hierarchy 1004 of FIG. 10.

FIG. 12 depicts a simplified diagram of a distributed system 1200 for implementing one of the aspects. In the illustrated aspect, distributed system 1200 includes one or more client computing devices 1202, 1204, 1206, and 1208, which are configured to execute and operate a client application such as a web browser, proprietary client (e.g., Oracle Forms), or the like over one or more network(s) 1210. Server 1212 may be communicatively coupled with client computing devices 1202, 1204, 1206, and 1208 via network(s) 1210.

In various aspects, server 1212 may be adapted to run one or more services or software applications provided by one or more of the components of the system. The services or software applications can include nonvirtual and virtual environments. Virtual environments can include those used for virtual events, tradeshows, simulators, classrooms, shopping exchanges, and enterprises, whether two- or three-dimensional (3D) representations, page-based logical environments, or otherwise. In some aspects, these services may be offered as web-based or cloud services or under a Software as a Service (Saas) model to the users of client computing devices 1202, 1204, 1206, and/or 1208. Users operating client computing devices 1202, 1204, 1206, and/or 1208 may in turn utilize one or more client applications to interact with server 1212 to utilize the services provided by these components.

In the configuration depicted in the figure, the software components 1218, 1220) and 1222 of distributed system 1200 are shown as being implemented on server 1212. In other aspects, one or more of the components of distributed system 1200 and/or the services provided by these components may also be implemented by one or more of the client computing devices 1202, 1204, 1206, and/or 1208. Users operating the client computing devices may then utilize one or more client applications to use the services provided by these components. These components may be implemented in hardware, firmware, software, or combinations thereof. It should be appreciated that various different system configurations are possible, which may be different from distributed system 1200. The aspect shown in the figure is thus one example of a distributed system for implementing an aspect system and is not intended to be limiting.

Client computing devices 1202, 1204, 1206, and/or 1208 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 12, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX®: or UNIX-like operating systems, including without limitation the variety of GNU/Linux operating systems, such as for example. Google Chrome OS. Alternatively, or in addition, client computing devices 1202, 1204, 1206, and 1208 may be any other electronic device, such as a thin-client computer, an Internet-enabled gaming system (e.g., a Microsoft Xbox gaming console with or without a Kinect® gesture input device), and/or a personal messaging device, capable of communicating over network(s) 1210.

Although distributed system 1200 is shown with four client computing devices, any number of client computing devices may be supported. Other devices, such as devices with sensors, etc., may interact with server 1212.

Network(s) 1210 in distributed system 1200 may be any type of network familiar to those skilled in the art that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 1210 can be a local area network (LAN), such as one based on Ethernet, Token-Ring and/or the like. Network(s) 1210 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.14 suite of protocols, Bluetooth®, and/or any other wireless protocol); and/or any combination of these and/or other networks.

Server 1212 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 1212 can include one or more virtual machines running virtual operating systems, or other computing architectures involving virtualization. One or more flexible pools of logical storage devices can be virtualized to maintain virtual storage devices for the server. Virtual networks can be controlled by server 1212 using software defined networking. In various aspects, server 1212 may be adapted to run one or more services or software applications described in the foregoing disclosure. For example, server 1212 may correspond to a server for performing processing described above according to an aspect of the present disclosure.

Server 1212 may run an operating system including any of those discussed above, as well as any commercially available server operating system. Server 1212 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 1212 may include one or more applications to analyze and consolidate data feeds and/or event updates received from users of client computing devices 1202, 1204, 1206, and 1208. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1212 may also include one or more applications to display the data feeds and/or real-time events via one or more display devices of client computing devices 1202, 1204, 1206, and 1208.

Distributed system 1200 may also include one or more databases 1214 and 1216. Databases 1214 and 1216 may reside in a variety of locations. By way of example, one or more of databases 1214 and 1216 may reside on a non-transitory storage medium local to (and/or resident in) server 1212. Alternatively, databases 1214 and 1216 may be remote from server 1212 and in communication with server 1212 via a network-based or dedicated connection. In one set of aspects, databases 1214 and 1216 may reside in a storage-area network (SAN). Similarly, any necessary files for performing the functions attributed to server 1212 may be stored locally on server 1212 and/or remotely, as appropriate. In one set of aspects, databases 1214 and 1216 may include relational databases, such as databases provided by Oracle, that are adapted to store, update, and retrieve data in response to SQL-formatted commands.

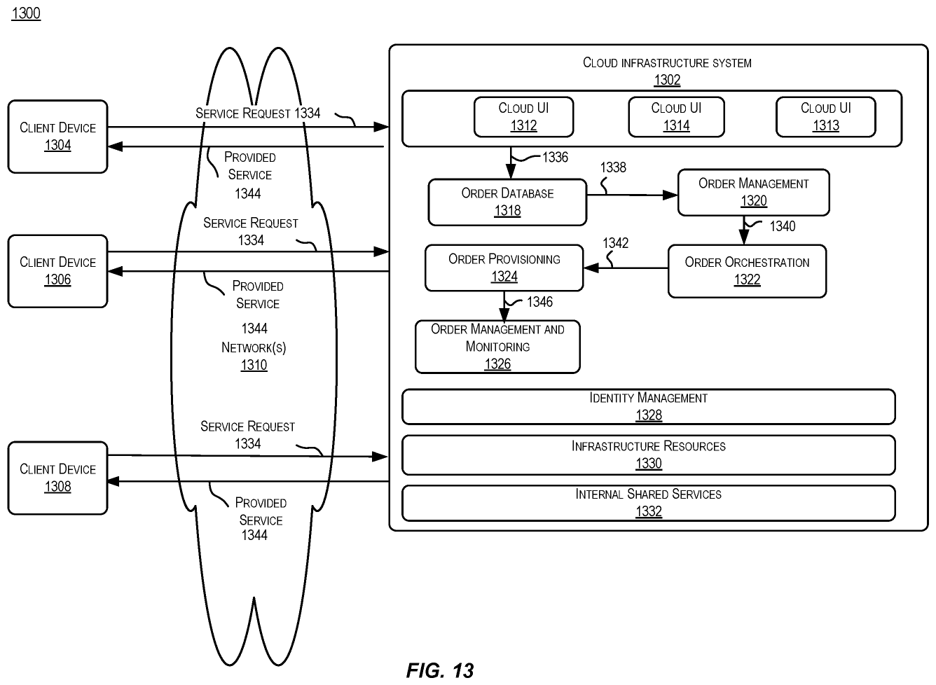

FIG. 13 is a simplified block diagram of one or more components of a system environment 1300 by which services provided by one or more components of an aspect system may be offered as cloud services in accordance with an aspect of the present disclosure. In the illustrated aspect, system environment 1300 includes one or more client devices 1304, 1306, and 1308 that may be used by users to interact with a cloud infrastructure system 1302 that provides cloud services. The client computing devices may be configured to operate a client application such as a web browser, a proprietary client application (e.g., Oracle Forms), or some other application, which may be used by a user of the client computing device to interact with cloud infrastructure system 1302 to use services provided by cloud infrastructure system 1302.

It should be appreciated that cloud infrastructure system 1302 depicted in the figure may have other components than those depicted. Further, the aspect shown in the figure is only one example of a cloud infrastructure system that may incorporate an aspect of the invention. In some other aspects, cloud infrastructure system 1302 may have more or fewer components than shown in the figure, may combine two or more components, or may have a different configuration or arrangement of components.

Client devices 1304, 1306, and 1308 may be devices similar to those described above for 1202, 1204, 1206, and 1208.

Although exemplary system environment 1300 is shown with three client computing devices, any number of client computing devices may be supported. Other devices such as devices with sensors, etc. may interact with cloud infrastructure system 1302.

Network(s) 1310 may facilitate communications and exchange of data between client devices 1304, 1306, and 1308 and cloud infrastructure system 1302. Each network may be any type of network familiar to those skilled in the art that can support data communications using any of a variety of commercially available protocols, including those described above for network(s) 1210.

Cloud infrastructure system 1302 may include one or more computers and/or servers that may include those described above for server 1212.

In certain aspects, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain aspects, cloud infrastructure system 1302 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

Large volumes of data, sometimes referred to as big data, can be hosted and/or manipulated by the infrastructure system on many levels and at different scales. Such data can include data sets that are so large and complex that it can be difficult to process using typical database management tools or traditional data processing applications. For example, terabytes of data may be difficult to store, retrieve, and process using personal computers or their rack-based counterparts. Such sizes of data can be difficult to work with using most current relational database management systems and desktop statistics and visualization packages. They can require massively parallel processing software running thousands of server computers, beyond the structure of commonly used software tools, to capture, curate, manage, and process the data within a tolerable elapsed time.

Extremely large data sets can be stored and manipulated by analysts and researchers to visualize large amounts of data, detect trends, and/or otherwise interact with the data. Tens, hundreds, or thousands of processors linked in parallel can act upon such data in order to present it or simulate external forces on the data or what it represents. These data sets can involve structured data, such as that organized in a database or otherwise according to a structured model, and/or unstructured data (e.g., emails, images, data blobs (binary large objects), web pages, complex event processing). By leveraging an ability of an aspect to relatively quickly focus more (or fewer) computing resources upon an objective, the cloud infrastructure system may be better available to carry out tasks on large data sets based on demand from a business, government agency, research organization, private individual, group of like-minded individuals or organizations, or other entity.

In various aspects, cloud infrastructure system 1302 may be adapted to automatically provision, manage and track a customer's subscription to services offered by cloud infrastructure system 1302. Cloud infrastructure system 1302 may provide the cloud services via different deployment models. For example, services may be provided under a public cloud model in which cloud infrastructure system 1302 is owned by an organization selling cloud services (e.g., owned by Oracle) and the services are made available to the general public or different industry enterprises. As another example, services may be provided under a private cloud model in which cloud infrastructure system 1302 is operated solely for a single organization and may provide services for one or more entities within the organization. The cloud services may also be provided under a community cloud model in which cloud infrastructure system 1302 and the services provided by cloud infrastructure system 1302 are shared by several organizations in a related community. The cloud services may also be provided under a hybrid cloud model, which is a combination of two or more different models.

In some aspects, the services provided by cloud infrastructure system 1302 may include one or more services provided under Software as a Service (Saas) category, Platform as a Service (PaaS) category, Infrastructure as a Service (IaaS) category, or other categories of services including hybrid services. A customer, via a subscription order, may order one or more services provided by cloud infrastructure system 1302. Cloud infrastructure system 1302 then performs processing to provide the services in the customer's subscription order.

In some aspects, the services provided by cloud infrastructure system 1302 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the Saas platform, customers can utilize applications executing on the cloud infrastructure system.

Customers can acquire the application services without the need for customers to purchase separate licenses and support. Various different SaaS services may be provided. Examples include, without limitation, services that provide solutions for sales performance management, enterprise integration, and business flexibility for large organizations.

In some aspects, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some aspects, platform services provided by the cloud infrastructure system may include database cloud services, middleware cloud services (e.g., Oracle Fusion Middleware services), and Java cloud services. In one aspect, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain aspects, cloud infrastructure system 1302 may also include infrastructure resources 1330 for providing the resources used to provide various services to customers of the cloud infrastructure system. In one aspect, infrastructure resources 1330 may include pre-integrated and optimized combinations of hardware, such as servers, storage, and networking resources to execute the services provided by the PaaS platform and the SaaS platform.

In some aspects, resources in cloud infrastructure system 1302 may be shared by multiple users and dynamically re-allocated per demand. Additionally, resources may be allocated to users in different time zones. For example, cloud infrastructure system 1302 may enable a first set of users in a first time zone to utilize resources of the cloud infrastructure system for a specified number of hours and then enable the re-allocation of the same resources to another set of users located in a different time zone, thereby maximizing the utilization of resources.

In certain aspects, a number of internal shared services 1332 may be provided that are shared by different components or modules of cloud infrastructure system 1302 and by the services provided by cloud infrastructure system 1302. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

In certain aspects, cloud infrastructure system 1302 may provide comprehensive management of cloud services (e.g., SaaS, PaaS, and IaaS services) in the cloud infrastructure system. In one aspect, cloud management functionality may include capabilities for provisioning, managing and tracking a customer's subscription received by cloud infrastructure system 1302, and the like.

In one aspect, as depicted in the figure, cloud management functionality may be provided by one or more modules, such as an order management module 1320, an order orchestration module 1322, an order provisioning module 1324, an order management and monitoring module 1326, and an identity management module 1328. These modules may include or be provided using one or more computers and/or servers, which may be general purpose computers, specialized server computers, server farms, server clusters, or any other appropriate arrangement and/or combination.

In operation 1334, a customer using a client device, such as client device 1304, 1306 or 1308, may interact with cloud infrastructure system 1302 by requesting one or more services provided by cloud infrastructure system 1302 and placing an order for a subscription for one or more services offered by cloud infrastructure system 1302. In certain aspects, the customer may access a cloud User Interface (UI), cloud UI 1312, cloud UI 1314 and/or cloud UI 1313 and place a subscription order via these UIs. The order information received by cloud infrastructure system 1302 in response to the customer placing an order may include information identifying the customer and one or more services offered by the cloud infrastructure system 1302 that the customer intends to subscribe to.

After an order has been placed by the customer, the order information is received via the cloud UIs, 1312, 1314 and/or 1313.

At operation 1336, the order is stored in order database 1318. Order database 1318 can be one of several databases operated by cloud infrastructure system 1302 and operated in conjunction with other system elements.

At operation 1338, the order information is forwarded to an order management module 1320. In some instances, order management module 1320 may be configured to perform billing and accounting functions related to the order, such as verifying the order, and upon verification, booking the order.

At operation 1340, information regarding the order is communicated to an order orchestration module 1322. Order orchestration module 1322 may utilize the order information to orchestrate the provisioning of services and resources for the order placed by the customer. In some instances, order orchestration module 1322 may orchestrate the provisioning of resources to support the subscribed services using the services of order provisioning module 1324.

In certain aspects, order orchestration module 1322 enables the management of business processes associated with each order and applies business logic to determine whether an order should proceed to provisioning. At operation 1342, upon receiving an order for a new subscription, order orchestration module 1322 sends a request to order provisioning module 1324 to allocate resources and configure those resources needed to fulfill the subscription order. Order provisioning module 1324 enables the allocation of resources for the services ordered by the customer. Order provisioning module 1324 provides a level of abstraction between the cloud services provided by system environment 1300 and the physical implementation layer that is used to provision the resources for providing the requested services. Order orchestration module 1322 may thus be isolated from implementation details, such as whether or not services and resources are actually provisioned on the fly or pre-provisioned and only allocated/assigned upon request.

At operation 1342, once the services and resources are provisioned, a notification of the provided service may be sent to customers on client devices 1304, 1306 and/or 1308 by order provisioning module 1324 of cloud infrastructure system 1302.

At operation 1346, the customer's subscription order may be managed and tracked by an order management and monitoring module 1326. In some instances, order management and monitoring module 1326 may be configured to collect usage statistics for the services in the subscription order, such as the amount of storage used, the amount data transferred, the number of users, and the amount of system up time and system down time.

In certain aspects, cloud infrastructure system 1302 may include an identity management module 1328. Identity management module 1328 may be configured to provide identity services, such as access management and authorization services in cloud infrastructure system 1302. In some aspects, identity management module 1328 may control information about customers who wish to utilize the services provided by cloud infrastructure system 1302. Such information can include information that authenticates the identities of such customers and information that describes which actions those customers are authorized to perform relative to various system resources (e.g., files, directories, applications, communication ports, memory segments, etc.). Identity management module 1328 may also include the management of descriptive information about each customer and about how and by whom that descriptive information can be accessed and modified.

FIG. 14 illustrates an exemplary computer system 1400, in which various aspects of the present invention may be implemented. The computer system 1400 may be used to implement any of the computer systems described above. As shown in the figure, computer system 1400 includes a processing unit 1404 that communicates with a number of peripheral subsystems via a bus subsystem 1402. These peripheral subsystems may include a processing acceleration unit 1406, an I/O subsystem 1408, a storage subsystem 1418 and a communications subsystem 1424. Storage subsystem 1418 includes tangible computer-readable storage media 1420 and a system memory 1410.

Bus subsystem 1402 provides a mechanism for letting the various components and subsystems of computer system 1400 communicate with each other as intended. Although bus subsystem 1402 is shown schematically as a single bus, alternative aspects of the bus subsystem may utilize multiple buses. Bus subsystem 1402 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1686.1 standard.

Processing unit 1404, which can be implemented as one or more integrated circuits (e.g., a conventional microprocessor or microcontroller), controls the operation of computer system 1400. One or more processors may be included in processing unit 1404. These processors may include single core or multicore processors. In certain aspects, processing unit 1404 may be implemented as one or more independent processing units 1432 and/or 1434 with single or multicore processors included in each processing unit. In other aspects, processing unit 1404 may also be implemented as a quad-core processing unit formed by integrating two dual-core processors into a single chip.

In various aspects, processing unit 1404 can execute a variety of programs in response to program code and can maintain multiple concurrently executing programs or processes. At any given time, some or all of the program code to be executed can be resident in processing unit 1404 and/or in storage subsystem 1418. Through suitable programming, processing unit 1404 can provide various functionalities described above. Computer system 1400 may additionally include a processing acceleration unit 1406, which can include a digital signal processor (DSP), a special-purpose processor, and/or the like.

I/O subsystem 1408 may include user interface input devices and user interface output devices. User interface input devices may include a key board, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader, 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1400 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1400 may comprise a storage subsystem 1418 that comprises software elements, shown as being currently located within a system memory 1410. System memory 1410 may store program instructions that are loadable and executable on processing unit 1404, as well as data generated during the execution of these programs.

Depending on the configuration and type of computer system 1400, system memory 1410 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1404. In some implementations, system memory 1410 may include multiple different types of memory, such as static random access memory (SRAM) or dynamic random access memory (DRAM). In some implementations, a basic input/output system (BIOS), containing the basic routines that help to transfer information between elements within computer system 1400, such as during start-up, may typically be stored in the ROM.

By way of example, and not limitation, system memory 1410 also illustrates application programs 1412, which may include client applications, Web browsers, mid-tier applications, relational database management systems (RDBMS), etc., program data 1414, and an operating system 1416. By way of example, operating system 1416 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, Black Berry® 15 OS, and Palm® OS operating systems.

Storage subsystem 1418 may also provide a tangible computer-readable storage medium for storing the basic programming and data constructs that provide the functionality of some aspects. Software (programs, code modules, instructions) that when executed by a processor provide the functionality described above may be stored in storage subsystem 1418. These software modules or instructions may be executed by processing unit 1404. Storage subsystem 1418 may also provide a repository for storing data used in accordance with the present invention.

Storage subsystem 1418 may also include a computer-readable storage media reader 1422 that can further be connected to computer-readable storage media 1422. Together and, optionally, in combination with system memory 1410, computer-readable storage media 1422 may comprehensively represent remote, local, fixed, and/or removable storage devices plus storage media for temporarily and/or more permanently containing, storing, transmitting, and retrieving computer-readable information.

Computer-readable storage media 1422 containing code, or portions of code, can also include any appropriate media known or used in the art, including storage media and communication media, such as but not limited to, volatile and non-volatile, removable and non-removable media implemented in any method or technology for storage and/or transmission of information. This can include tangible, non-transitory computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. When specified, this can also include nontangible, transitory computer-readable media, such as data signals, data transmissions, or any other medium which can be used to transmit the desired information and which can be accessed by computer system 1400.

By way of example, computer-readable storage media 1422 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1420 may include, but is not limited to, Zip® drives, flash memory cards, universal serial bus (USB) flash drives, secure digital (SD) cards, DVD disks, digital video tape, and the like. Computer-readable storage media 1420 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1400.

Communications subsystem 1424 provides an interface to other computer systems and networks. Communications subsystem 1424 serves as an interface for receiving data from and transmitting data to other systems from computer system 1400. For example, communications subsystem 1424 may enable computer system 1400 to connect to one or more devices via the Internet. In some aspects, communications subsystem 1424 can include radio frequency (RF) transceiver components for accessing wireless voice and/or data networks (e.g., using cellular telephone technology, advanced data network technology, such as 4G, 4G or EDGE (enhanced data rates for global evolution), WiFi (IEEE 802.28 family standards, or other mobile communication technologies, or any combination thereof), global positioning system (GPS) receiver components, and/or other components. In some aspects, communications subsystem 1424 can provide wired network connectivity (e.g., Ethernet) in addition to or instead of a wireless interface.

In some aspects, communications subsystem 1424 may also receive input communication in the form of structured and/or unstructured data feeds 1426, event streams 1428, event updates 1430, and the like on behalf of one or more users who may use computer system 1400.

By way of example, communications subsystem 1424 may be configured to receive unstructured data feeds 1426 in real-time from users of social media networks and/or other communication services such as Twitter® feeds, Facebook® updates, web feeds such as Rich

Site Summary (RSS) feeds, and/or real-time updates from one or more third party information sources.

Additionally, communications subsystem 1424 may also be configured to receive data in the form of continuous data streams, which may include event streams 1428 of real-time events and/or event updates 1430, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1424 may also be configured to output the structured and/or unstructured data feeds 1426, event streams 1428, event updates 1430, and the like to one or more databases that may be in communication with one or more streaming data source computers coupled to computer system 1400.

Computer system 1400 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1400 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various aspects.

In the foregoing specification, aspects of the invention are described with reference to specific aspects thereof, but those skilled in the art will recognize that the invention is not limited thereto. Various features and aspects of the above-described invention may be used individually or jointly. Further, aspects can be utilized in any number of environments and applications beyond those described herein without departing from the broader spirit and scope of the specification. The specification and drawings are, accordingly, to be regarded as illustrative rather than restrictive.

What is claimed is:

1. A method for curing defects in software applications, the method comprising:
receiving, from a first tracer configured to log tracing data for a first instance of a web page application, a first tracing log comprising information regarding a first plurality of spans, wherein each span of the first plurality of spans is associated with a corresponding event of the web page application;
generating, from the first tracing log, a first logical tree that comprises a first plurality of nodes, wherein each node comprises attributes of a respective span of the first plurality of spans, and wherein a first subset of the first plurality of nodes is arranged to represent a first chronological order of execution of events within the first instance of the web page application, and wherein a first additional node of the first plurality of nodes is outside of the first chronological order;
receiving, from a second tracer configured to log tracing data for a second instance of the web page application, a second tracing log comprising information regarding a second plurality of spans, wherein each span of the second plurality of spans is associated with a corresponding event of the web page application;
generating, from the second tracing log, a second logical tree that comprises a second plurality of nodes, wherein each node comprises attributes of a respective span of the second plurality of spans, and wherein a second subset of the second plurality of nodes is arranged to represent a second chronological order of execution of events within the second instance of the web page application, and wherein a second additional node of the second plurality of nodes is outside of the second chronological order;
extracting, from nodes of the first logical tree and the nodes of the second logical tree, a set of spans, the extracting comprising:
identifying, (i) a correspondence between a first node in the first logical tree and a second node in the second logical tree and (ii) a first difference between a first attribute of the first node and a second attribute of the second node;
identifying, (i) a plurality of common nodes between the first subset of the first plurality of nodes and the second subset of the second plurality of nodes, and (ii) a second difference between the first chronological order and the second chronological order;
extracting one or more spans based on the first difference and the second difference; and
generating a textual report of the set of spans.

2. The method of claim 1, further comprising:
identifying, from the extracted spans, a software defect in the second instance of the web page application; and
responsive to identifying the software defect, correcting the software defect in the second instance of the web page application.

3. The method of claim 1, wherein the attributes include one or more of: a type of error associated with the span, a timestamp, a duration of the span, a type of operation, a type of event, a parent span of the span, and a child span of the span.

4. The method of claim 1 further comprising:
determining, from the identified spans, the first difference and the second difference to be greater than a predetermined threshold; and
receiving, from a third tracer configured to log tracing data for a third instance of the web page application, a third tracing log comprising information regarding a third plurality of spans, wherein each span of the third plurality of spans is associated with a corresponding event of the web page application.

5. The method of claim 1, wherein the second instance of the web page application is a simulation of the first instance of the web page application.

6. The method of claim 1, wherein the textual report includes a comparison of the second logical tree and the second logical tree.

7. The method of claim 1 further comprising:
identifying an additional difference between an additional attribute of the first node and an additional attribute of the second node; and
ignoring the additional difference based on attribute type.

8. A system comprising:
a non-transitory computer-readable medium storing computer-executable program instructions; and
a processing device communicatively coupled to the non-transitory computer-readable medium for executing the computer-executable program instructions, wherein executing the computer-executable program instructions configures the processing device to perform operations comprising:
receiving, from a first tracer configured to log tracing data for a first instance of a web page application, a first tracing log comprising information regarding a first plurality of spans, wherein each span of the first plurality of spans is associated with a corresponding event of the web page application;
generating, from the first tracing log, a first logical tree that comprises a first plurality of nodes, wherein each node comprises attributes of a respective span of the first plurality of spans, and wherein a first subset of the first plurality of nodes is arranged to represent a first chronological order of execution of events within the first instance of the web page application, and wherein a first additional node of the first plurality of nodes is outside of the first chronological order;
receiving, from a second tracer configured to log tracing data for a second instance of the web page application, a second tracing log comprising information regarding a second plurality of spans, wherein each span of the second plurality of spans is associated with a corresponding event of the web page application;
generating, from the second tracing log, a second logical tree that comprises a second plurality of nodes, wherein each node comprises attributes of a respective span of the second plurality of spans, and wherein a second subset of the second plurality of nodes is arranged to represent a second chronological order of execution of events within the second instance of the web page application, and wherein a second additional node of the second plurality of nodes is outside of the second chronological order;
extracting, from nodes of the first logical tree and the nodes of the second logical tree, a set of spans, the extracting comprising:
identifying, (i) a correspondence between a first node in the first logical tree and a second node in the second logical tree and (ii) a first difference between a first attribute of the first node and a second attribute of the second node;
identifying, (i) a plurality of common nodes between the first subset of the first plurality of nodes and the second subset of the second plurality of nodes, and (ii) a second difference between the first chronological order and the second chronological order;
extracting one or more spans based on the first difference and the second difference; and
generating a textual report of the set of spans.

9. The system of claim 8, wherein executing the computer-executable program instructions configures the processing device to perform operations comprising:
identifying, from the extracted spans, a software defect in the second instance of the web page application; and
responsive to identifying the software defect, correcting the software defect in the second instance of the web page application.

10. The system of claim 8, wherein the attributes include one or more of: a type of error associated with the span, a timestamp, a duration of the span, a type of operation, a type of event, a parent span of the span, and a child span of the span.

11. The system of claim 8, wherein executing the computer-executable program instructions configures the processing device to perform operations comprising:
determining, from the identified spans, the first difference and the second difference to be greater than a predetermined threshold; and
receiving, from a third tracer configured to log tracing data for a third instance of the web page application, a third tracing log comprising information regarding a third plurality of spans, wherein each span of the third plurality of spans is associated with a corresponding event of the web page application.

12. The system of claim 8, wherein the second instance of the web page application is a simulation of the first instance of the web page application.

13. The system of claim 8, wherein the textual report includes a comparison of the second logical tree and the second logical tree.

14. The system of claim 8, wherein executing the computer-executable program instructions configures the processing device to perform operations comprising:
identifying an additional difference between an additional attribute of the first node and an additional attribute of the second node; and
ignoring the additional difference based on attribute type.

15. A non-transitory computer-readable storage medium storing computer-executable program instructions, wherein when executed by a processing device, the computer-executable program instructions cause the processing device to perform operations comprising:
receiving, from a first tracer configured to log tracing data for a first instance of a web page application, a first tracing log comprising information regarding a first plurality of spans, wherein each span of the first plurality of spans is associated with a corresponding event of the web page application;
generating, from the first tracing log, a first logical tree that comprises a first plurality of nodes, wherein each node comprises attributes of a respective span of the first plurality of spans, and wherein a first subset of the first plurality of nodes is arranged to represent a first chronological order of execution of events within the first instance of the web page application, and wherein a first additional node of the first plurality of nodes is outside of the first chronological order;
receiving, from a second tracer configured to log tracing data for a second instance of the web page application, a second tracing log comprising information regarding a second plurality of spans, wherein each span of the second plurality of spans is associated with a corresponding event of the web page application;
generating, from the second tracing log, a second logical tree that comprises a second plurality of nodes, wherein each node comprises attributes of a respective span of the second plurality of spans, and wherein a second subset of the second plurality of nodes is arranged to represent a second chronological order of execution of events within the second instance of the web page application, and wherein a second additional node of the second plurality of nodes is outside of the second chronological order;
extracting, from nodes of the first logical tree and the nodes of the second logical tree, a set of spans, the extracting comprising:
identifying, (i) a correspondence between a first node in the first logical tree and a second node in the second logical tree and (ii) a first difference between a first attribute of the first node and a second attribute of the second node;
identifying, (i) a plurality of common nodes between the first subset of the first plurality of nodes and the second subset of the second plurality of nodes, and (ii) a second difference between the first chronological order and the second chronological order;
extracting one or more spans based on the first difference and the second difference; and
generating a textual report of the set of spans.

16. The non-transitory computer-readable medium of claim 15, wherein when executed by a processing device, the computer-executable program instructions cause the processing device to perform operations comprising:
identifying, from the extracted spans, a software defect in the second instance of the web page application; and
responsive to identifying the software defect, correcting the software defect in the second instance of the web page application.

17. The non-transitory computer-readable medium of claim 15, wherein the attributes include one or more of: a type of error associated with the span, a timestamp, a duration of the span, a type of operation, a type of event, a parent span of the span, and a child span of the span.

18. The non-transitory computer-readable medium of claim 15, wherein when executed by a processing device, the computer-executable program instructions cause the processing device to perform operations comprising:
determining, from the identified spans, the first difference and the second difference to be greater than a predetermined threshold; and
receiving, from a third tracer configured to log tracing data for a third instance of the web page application, a third tracing log comprising information regarding a third plurality of spans, wherein each span of the third plurality of spans is associated with a corresponding event of the web page application.

19. The non-transitory computer-readable medium of claim 15, wherein the second instance of the web page application is a simulation of the first instance of the web page application.

20. The non-transitory computer-readable medium of claim 19, wherein when executed by a processing device, the computer-executable program instructions cause the processing device to perform operations comprising:
identifying an additional difference between an additional attribute of the first node and an additional attribute of the second node; and
ignoring the additional difference based on attribute type.
